(19) United States
(12) Patent Application Publication
(10) Pub. No.: US 2011/0118987 A1
(43) Pub. Date: May 19, 2011

(54) PREDICTIVE BLOOD SUGAR LEVEL CALCULATING DEVICE, PREDICTIVE BLOOD SUGAR LEVEL CALCULATING METHOD, AND PROGRAM THEREOF

(75) Inventors: Jun Takeuchi, Tokyo-to (JP); Junko Hasegawa, Abiko-shi (JP); Megumi Sano, Kawasaki-shi (JP); Daichi Shimatsu, Tokyo-to (JP)

(73) Assignee: SEIKO EPSON CORPORATION, Tokyo (JP)

(21) Appl. No.: 12/946,961

(22) Filed: Nov. 16, 2010

(30) Foreign Application Priority Data
Nov. 18, 2009 (JP) 2009-262621

(51) Int. Cl. G06F 19/00

(52) U.S. Cl. 702/19

(57) ABSTRACT

A predictive blood sugar level calculating device acquires meal information about meal intake, calorie consumption information about calorie consumption, pulse information, and the like, calculates predictive blood sugar level change curves indicating change in blood sugar levels based on the plurality of information in a time series using predetermined numerical formulas, and combines the predictive blood sugar level change curves, thereby reducing an error between the calculated predictive blood sugar level curve and an actual change in a blood sugar level occurring in a human body.

The entire disclosure of Japanese Patent Application No. 2009-262621, filed Nov. 18, 2009 is expressly incorporated by reference herein.

### BACKGROUND

1. Technical Field

The present invention relates to a predictive blood sugar level calculating device, a predictive blood sugar level calculating method, and a program thereof.

2. Related Art

JP-A-2005-328924 describes a blood sugar level predicting device which creates in advance a prediction model of predicting a blood sugar level of a user on the basis of historical data on calorie intake of the user and historical data on calorie consumption of the user, and predicts a blood sugar level of the user from the calorie intake of the user and the calorie consumption of the user using the prediction model.

In the technique, it is possible to predict a blood sugar level at any point in time, but it is not possible to predict how the blood sugar level changes in a time series.

### SUMMARY

An advantage of some aspects of the invention is to provide a predictive blood sugar level calculating device, a predictive blood sugar level calculating method, and a program thereof, which can predict change in the blood sugar level with high precision.

According to a first aspect of the invention, there is provided a predictive blood sugar level calculating device, which calculates a predictive blood sugar level change curve indicating change in a predictive value of a blood sugar level of a user in a time series, the device including: a meal information acquiring unit that acquires meal information about meal intake of the user; a calorie consumption information acquiring unit that acquires calorie consumption information about calorie consumption of the user; a first predictive blood sugar level calculating unit that calculates a first predictive blood sugar level change curve based on the meals using the meal information and a predetermined numerical formula; a second predictive blood sugar level calculating unit that calculates a second predictive blood sugar level change curve based on the calorie consumption using the calorie consumption information and a predetermined numerical formula; and a third predictive blood sugar level calculating unit that calculates a third predictive blood sugar level change curve based on the meals and the calorie consumption by combining the first predictive blood sugar level change curve and the second predictive blood sugar level change curve. With such a configuration, it is possible to calculate the third predictive blood sugar level change curve indicating the change in the blood sugar level in a time series. Particularly, since the third predictive blood sugar level change curve is calculated on the basis of the meals and the calorie consumption, it is possible to calculate the third predictive blood sugar level change curve with high precision and with a small error from the actual change in the blood sugar level occurring in a human body. In addition, the first predictive blood sugar level change curve indicating the change in the predictive blood sugar level caused by the meals and the second predictive blood sugar level change curve indicating the change in the predictive blood sugar level caused by the calorie consumption are independently determined, and thus it is possible to efficiently calculate the predictive blood sugar level change curve with high precision for each of the first predictive blood sugar level change curve and the second predictive blood sugar level change curve. For this reason, it is possible to efficiently calculate the third predictive blood sugar level change curve with higher precision, with a smaller error from the actual change in the blood sugar level occurring in the human body.

The predictive blood sugar level calculating device may further include a drinking information acquiring unit that acquires drinking information about drinking of the user, and the second predictive blood sugar level calculating unit may calculate a predictive calorie consumption change curve indicating change in a predictive value of calorie consumption in a time series when the user drinks using the drinking information and a predetermined numerical formula, and calculate the second predictive blood sugar level change curve when the user drinks using the predictive calorie consumption change curve and a predetermined numerical formula. With such a configuration, even when the change in the calorie consumption caused by drinking cannot be measured by a measuring device, it is possible to calculate the second predictive blood sugar level change curve at the time of drinking with high precision by predicting the change in the calorie consumption caused by drinking. For this reason, it is possible to calculate the third predictive blood sugar level change curve with higher precision, with a smaller error from the actual change in the blood sugar level occurring in the human body.

In the predictive blood sugar level calculating device, the second predictive blood sugar level calculating unit may calculate the second predictive blood sugar level change curve with respect to a period when the calorie consumption information cannot be acquired using calorie consumption information of a different period when the calorie consumption information can be acquired and a predetermined numerical formula. With such a configuration, even when there is a period when the calorie consumption cannot normally be measured due to breakdown and failure of a measuring device, it is possible to supplement this by using calorie consumption of the different period when the calorie consumption was normally measured. For this reason, it is possible to calculate the third predictive blood sugar level change curve with higher precision, with a smaller error from the actual change in the blood sugar level occurring in the human body.

The predictive blood sugar level calculating device may further include a fourth predictive blood sugar level calculating unit that calculates a fourth predictive blood sugar level change curve based on basal metabolism using basal metabolism information about the basal metabolism of the user and a predetermined numerical formula, and the third predictive blood sugar level calculating unit may calculate the third predictive blood sugar level change curve based on the meals, the calorie consumption, and the basal metabolism by combining the first predictive blood sugar level change curve, the second predictive blood sugar level change curve, and the fourth predictive blood sugar level change curve. With such a configuration, since the change in the blood sugar level caused by the basal metabolism of the user is considered, it is possible to calculate the third predictive blood sugar level change curve with higher precision, with a smaller error from the actual change in the blood sugar level occurring in the human body.

The predictive blood sugar level calculating device may further include a fifth predictive blood sugar level calculating unit that calculates a fifth predictive blood sugar level change curve based on a liver function using liver function information about the liver function of the user and a predetermined numerical formula, wherein the third predictive blood sugar level calculating unit may calculate the third predictive blood sugar level change curve based on the meals, the calorie consumption, the basal metabolism, and the liver function by combining the first predictive blood sugar level change curve, the second predictive blood sugar level change curve, the fourth predictive blood sugar level change curve, and the fifth predictive blood sugar level change curve. With such a configuration, since the change in the blood sugar level caused by the liver function of the user is considered, it is possible to calculate the third predictive blood sugar level change curve with higher precision, with a smaller error from the actual change in the blood sugar level occurring in the human body.

The predictive blood sugar level calculating device may selectively calculate different kinds of a plurality of predictive blood sugar level change curves, and the third predictive blood sugar level calculating unit may calculate the third predictive blood sugar level change curve by combining the plurality of selectively calculated predictive blood sugar level change curves. With such a configuration, since it is possible to selectively calculate the predictive blood sugar level change curves necessary for the user, it is possible to suppress a burden applied to the device calculating the predictive blood sugar level change curve. For this reason, it is possible to more efficiently calculate the third predictive blood sugar level change curve with high precision.

In the predictive blood sugar level calculating device, the third predictive blood sugar level calculating unit may calculate the third predictive blood sugar level change curve at every predetermined unit of time. With such a configuration, it is possible to continuously calculate the third predictive blood sugar level change curve with high precision always on the basis of the latest information.

According to a second aspect of the invention, there is provided a predictive blood sugar level calculating method by a predictive blood sugar level calculating device, which calculates a predictive blood sugar level change curve indicating change in a predictive value of a blood sugar level of a user in a time series, the method including: acquiring meal information about meal intake of the user, by a meal information acquiring unit of the predictive blood sugar level calculating device; acquiring calorie consumption information about calorie consumption of the user, by a calorie consumption information acquiring unit of the predictive blood sugar level calculating device; calculating a first predictive blood sugar level change curve based on the meals using the meal information and a predetermined numerical formula, by a first predictive blood sugar level calculating unit of the predictive blood sugar level calculating device; calculating a second predictive blood sugar level change curve based on the calorie consumption using the calorie consumption information and a predetermined numerical formula, by a second predictive blood sugar level calculating unit of the predictive blood sugar level calculating device; and calculating a third predictive blood sugar level change curve based on the meals and the calorie consumption by combining the first predictive blood sugar level change curve and the second predictive blood sugar level change curve, by a third predictive blood sugar level calculating unit of the predictive blood sugar level calculating device. With such a configuration, it is possible to cause a computer to calculate the third predictive blood sugar level change curve indicating the change in the blood sugar level in a time series. Particularly, since the third predictive blood sugar level change curve is calculated on the basis of the meals and the calorie consumption by a computer, it is possible to calculate the third predictive blood sugar level change curve with high precision and with a small error from the actual change in the blood sugar level occurring in a human body.

According to a third aspect of the invention, there is provided a program for a predictive blood sugar level calculating device, which calculates a predictive blood sugar level change curve indicating change in a predictive value of a blood sugar level of a user in a time series, the program causing a computer to function as: a meal information acquiring unit that acquires meal information about meal intake of the user; a calorie consumption information acquiring unit that acquires calorie consumption information about calorie consumption of the user; a first predictive blood sugar level calculating unit that calculates a first predictive blood sugar level change curve based on the meals using the meal information and a predetermined numerical formula; a second predictive blood sugar level calculating unit that calculates a second predictive blood sugar level change curve based on the calorie consumption using the calorie consumption information and a predetermined numerical formula; and a third predictive blood sugar level calculating unit that calculates a third predictive blood sugar level change curve based on the meals and the calorie consumption by combining the first predictive blood sugar level change curve and the second predictive blood sugar level change curve. With such a configuration, it is possible to calculate the third predictive blood sugar level change curve indicating the change in the blood sugar level in a time series. Particularly, since the third predictive blood sugar level change curve is calculated on the basis of the meals and the calorie consumption, it is possible to cause a computer to calculate the third predictive blood sugar level change curve with high precision and with a small error from the actual change in the blood sugar level occurring in a human body.

### BRIEF DESCRIPTION OF THE DRAWINGS

The invention will be described with reference to the accompanying drawings, wherein like numbers reference like elements.

FIG. 1 shows a device configuration of a predictive blood sugar level calculating system according to a first embodiment.

FIG. 2 shows a functional configuration of a predictive blood sugar level calculating device according to the first embodiment.

FIG. 3 shows a process of calculating a second predictive blood sugar level change curve.

FIG. 4A, FIG. 4B, and FIG. 4C shows second-meal effect value determining tables.

FIG. 5 shows a process of calculating a second predictive blood sugar level change curve.

FIG. 6 shows a process of calculating a predictive calorie consumption change curve.

FIG. 7 shows a physical condition determining table.

FIG. 8 shows a process sequence of the predictive blood sugar level calculating device.

FIG. 9 shows information output by an output unit.

FIG. 10 shows a functional configuration of a predictive blood sugar level calculating device according to a second embodiment.

FIG. 11 shows a process of calculating a fourth predictive blood sugar level change curve.

FIG. 12 shows a process sequence of the predictive blood sugar level calculating device according to the second embodiment.

FIG. 13 shows a functional configuration of a predictive blood sugar level calculating device according to a third embodiment.

FIG. 14 shows a process of calculating a fifth predictive blood sugar level change curve.

FIG. 15 shows a process sequence of the predictive blood sugar level calculating device according to the third embodiment.

FIG. 16 shows a hardware configuration of the predictive blood sugar level calculating device.

### DESCRIPTION OF EXEMPLARY EMBODIMENTS

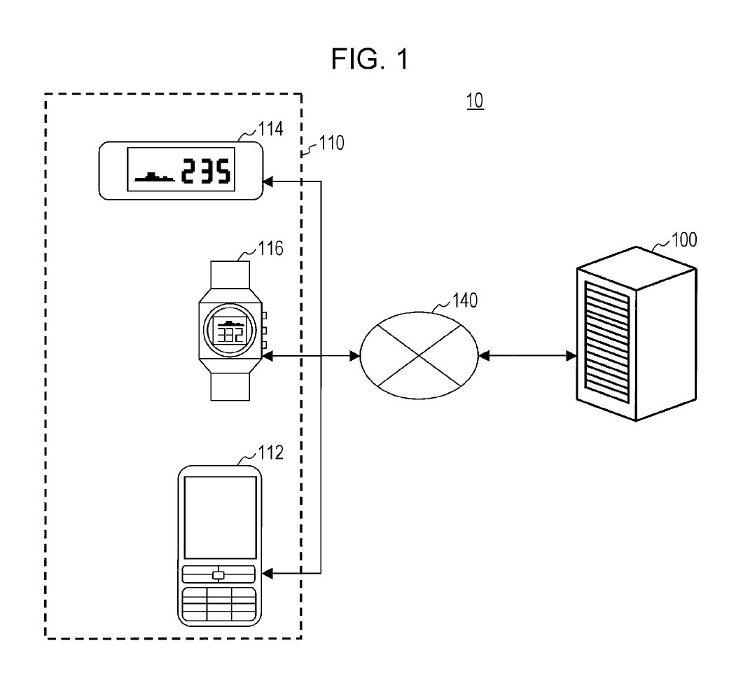

FIG. 1 shows a device configuration of a predictive blood sugar level calculating system 10 according to a first embodiment. The predictive blood sugar level calculating system 10 calculates a predictive blood sugar level change curve and outputs the calculated predictive blood sugar level change curve. The predictive blood sugar level change curve indicates change in a predictive blood sugar level of a user in a time series. The predictive blood sugar level indicates a predictive value of the blood sugar level of the user.

The predictive blood sugar level calculating system 10 is provided with a predictive blood sugar level calculating device 100 and an input device group 110. The input device group 110 indicates a collection of a plurality of input devices of the user. The input device group 110 is used to input various kinds of information for calculating the predictive blood sugar level change curve of the user. The input device group 110 includes a terminal device 112, an activity meter 114, and a pulsimeter 116.

Meal information about meal intake of the user is input to the terminal device 112. The meal information includes information such as date, time, and calorie intake. Drinking information about drinking of the user is input to the terminal device 112. The drinking information includes information such as data, time, and an amount of ethanol. Body characteristic information about body characteristics of the user is input to the terminal device 112. The body characteristic information includes information such as a value indicating resistance against alcohol. The terminal device 112 transmits the input meal information, drinking information, and body characteristic information to the predictive blood sugar level calculating device 100 through a communication network 140, a wired communication, or a wireless communication. An example of the terminal device 112 includes a mobile phone, a PDA (Personal Digital Assistant), and a personal computer. An example of the communication network 140 includes the Internet, a LAN, Wi-Fi, a fixed telephone network and a mobile phone network.

The activity meter 114 measures the calorie consumption of the user. Specifically, the activity meter 114 detects change in posture of the activity meter 114 according to motion such as walking and exercise by the user using a sensor such as an acceleration sensor. The activity meter 114 calculates calorie consumption of the user on the basis of a signal output from the sensor using an electronic circuit such as an IC. The activity meter 114 transmits the calorie consumption information about the measured calorie consumption of the user to the predictive blood sugar level calculating device 100 through the communication network 140, the wire communication, or the wireless communication. The activity meter 114 may specify an action of the user. For example, the activity meter 114 specifies the action of the user on the basis of the value of the calorie consumption calculated as described above and the change thereof. The activity meter 114 transmits the calorie consumption information including information indicating the specific action of the user to the predictive blood sugar level calculating device 100 through the communication network 140, the wire communication, or the wireless communication.

The pulsimeter 116 measures a pulse of the user. Specifically, the pulsimeter 116 irradiates a blood vessel with infrared rays using an infrared ray irradiation device. The pulsimeter 116 detects intensity of the infrared rays reflected from the blood vessel or intensity of the infrared ray penetrating the blood vessel using an imaging device such as a CCD. The pulsimeter 116 calculates a pulse of the user on the basis of a signal output from the imaging device using an electronic circuit such as an IC. The pulsimeter 116 transmits the pulse information about the measured pulse of the user to the predictive blood sugar level calculating device 100 through the communication network 140, the wire communication, or the wireless communication. The pulsimeter 116 may calculate calorie consumption of the user. For example, the pulsimeter 116 calculates the calorie consumption of the user on the basis of the pulse of the user calculated as described above. The pulsimeter 116 transmits the calorie consumption information about the measured calorie consumption of the user to the predictive blood sugar level calculating device 100 through the communication network 140, the wire communication, or the wireless communication. The pulsimeter 116 may specify an action of the user. For example, the pulsimeter 116 specifies the action of the user on the basis of the value of at least any one of the pulse and the calorie consumption of the user calculated as described above and the change thereof. The pulsimeter 116 transmits the calorie consumption information including information indicating the specific action of the user to the predictive blood sugar level calculating device 100 through the communication network 140, the wire communication, or the wireless communication.

The predictive blood sugar level calculating device 100 calculates a predictive blood sugar level change curve on the basis of the various kinds of information transmitted from the input device group 110 using a computer. The predictive blood sugar level calculating device 100 outputs the calculated predictive blood sugar level change curve. The predictive blood sugar level calculating device 100 can calculate predictive blood sugar level change curves for each of a plurality of users. Accordingly, the predictive blood sugar level calculating device 100 acquires various kinds of information from a plurality of input device groups 110 of each of a plurality of users. In the embodiment, to make description be easily understood, the input device group 110 of one user is described and shown, and the input device groups 110 of the other users are not described or shown. The input device groups 110 of the other users are the same as the input device group 110 of the one user.

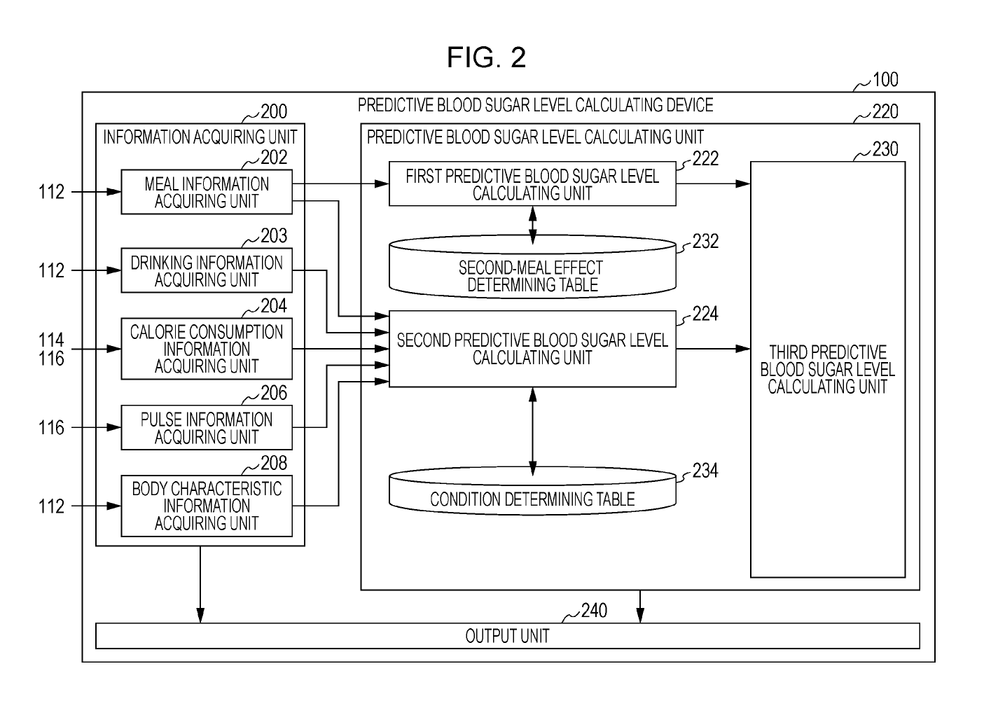

FIG. 2 shows a functional configuration of the predictive blood sugar level calculating device 100 according to the first embodiment. The predictive blood sugar level calculating device 100 is provided with an information acquiring unit 200, a predictive blood sugar level calculating unit 220, and an output unit 240. The information acquiring unit 200 acquires various kinds of information for calculating the predictive blood sugar level change curve. The predictive blood sugar level calculating unit 220 calculates the predictive blood sugar level change curve on the basis of the various kinds of information acquired by the information acquiring unit 200. The output unit 240 outputs the predictive blood sugar level change curve calculated by the predictive blood sugar level calculating unit 220.

The information acquiring unit 200 is provided with a meal information acquiring unit 202, a drinking information acquiring unit 203, a calorie consumption information acquiring unit 204, a pulse information acquiring unit 206, and a body characteristic information acquiring unit 208. The meal information acquiring unit 202 acquires meal information. Specifically, the meal information acquiring unit 202 acquires the meal information from the terminal device 112. The meal information acquiring unit 202 may acquire the meal information from a device other than the terminal device 112. The drinking information acquiring unit 203 acquires drinking information. Specifically, the drinking information acquiring unit 203 acquires the drinking information from the terminal device 112. The drinking information acquiring unit 203 may acquire the drinking information from a device other than the terminal device 112. The calorie consumption information acquiring unit 204 acquires calorie consumption information. Specifically, the calorie consumption information acquiring unit 204 acquires the calorie consumption information from the activity meter 114. The calorie consumption information acquiring unit 204 also acquires calorie consumption information from the pulsimeter 116. The calorie consumption information acquiring unit 204 may acquire the calorie consumption information from a device other than the activity meter 114 and the pulsimeter 116.

The pulse information acquiring unit 206 acquires pulse information. Specifically, the pulse information acquiring unit 206 acquires the pulse information from the pulsimeter 116. The pulse information acquiring unit 206 may acquire the pulse information from a device other than the pulsimeter 116. The body characteristic information acquiring unit 208 acquires body characteristic information. Specifically, the body characteristic information acquiring unit 208 acquires the body characteristic information from the terminal device 112. The body characteristic information acquiring unit 208 may acquire the body characteristic information from a device other than the terminal device 112.

The predictive blood sugar level calculating unit 220 calculates a third predictive blood sugar level change curve based on meals and calorie consumption on the basis of the meal information acquired by the meal information acquiring unit 202 and the calorie consumption information acquired by the calorie consumption information acquiring unit 204. The third predictive blood sugar level change curve indicates a predictive blood sugar level change curve based on a plurality of blood sugar level change factors calculated by combining a plurality of predictive blood sugar level change curves with different blood sugar level change factors. The predictive blood sugar level calculating unit 220 is provided with a first predictive blood sugar level calculating unit 222, a second predictive blood sugar level calculating unit 224, and a third predictive blood sugar level calculating unit 230.

The first predictive blood sugar level calculating unit 222 calculates a first predictive blood sugar level change curve using the meal information acquired by the meal information acquiring unit 202 and a predetermined numerical formula. The first predictive blood sugar level change curve indicates a predictive blood sugar level change curve based on the meal intake of the user. The second predictive blood sugar level calculating unit 224 calculates a second predictive blood sugar level change curve using the calorie consumption information acquired by the calorie consumption information acquiring unit 204 and a predetermined numerical formula. The second predictive blood sugar level change curve indicates a predictive blood sugar level change curve based on the calorie consumption of the user.

The third predictive blood sugar level calculating unit 230 calculates a third predictive blood sugar level change curve based on the meal intake of the user and the calorie consumption of the user by combining the first predictive sugar level change curve calculated by the first predictive blood sugar level calculating unit 222 and the second predictive blood sugar level change curve calculated by the second predictive blood sugar level calculating unit 224. For example, with respect to each time during a target period, the third predictive blood sugar level calculating unit 230 calculates a predictive value of a blood sugar level at the corresponding time by adding an increase or decrease in the blood sugar value at the corresponding time shown in the first predictive blood sugar level change curve and an increase or decrease in the blood sugar value at the corresponding time shown in the second predictive blood sugar level change curve, to a reference value of the blood sugar level of the user, an actually measured value of the user at the corresponding time (when the blood sugar level at the corresponding time is being measured), or a predictive value of the blood sugar level of the user at the corresponding time (when the blood sugar level at the corresponding time has been already measured). The third predictive blood sugar level calculating unit 230 calculates the third predictive blood sugar level change curve indicating change in the predictive value of the blood sugar level in a time series by calculating the predictive value of the blood sugar level every time for each unit of time (e.g., 4 seconds) during the target period.

The output unit 240 outputs the predictive blood sugar level change curve calculated by the predictive blood sugar level calculating unit 220. For example, the output unit 240 outputs the third predictive blood sugar level change curve based on the meals and the calorie consumption calculated by the predictive blood sugar level calculating unit 220. Specifically, the output unit 240 causes a display device to display the third predictive blood sugar level change curve. The output unit 240 is not limited thereto, and may output the third predictive blood sugar level change curve in another output type. For example, the output unit 240 may cause a printing device to print the third predictive blood sugar level change curve. The output unit 240 may transmit the third predictive blood sugar level change curve to an external information processing device. The output unit 240 may store the third predictive blood sugar level change curve in an external recording medium.

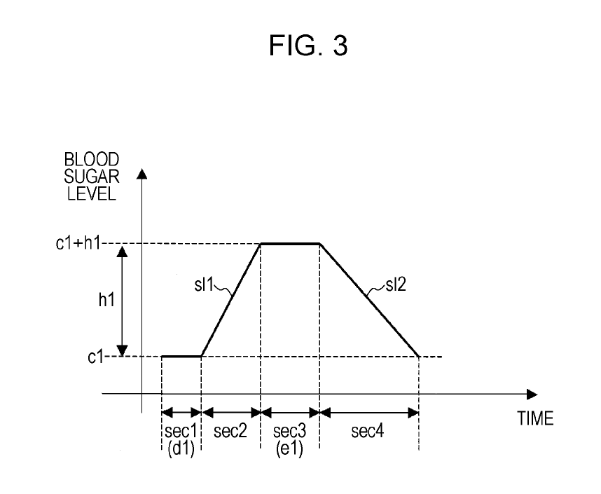

FIG. 3 shows a process of calculating the first predictive blood sugar level change curve. The first predictive blood sugar level change curve includes a delay period sect, a rising period sec2, an equilibrium period sec3, and a falling period sec4. The delay period sec1 indicates a period from when a meal starts to when the blood sugar level starts rising. The rising period sec2 indicates a period from when the blood sugar level starts rising to when the blood sugar level reaches a peak value. The equilibrium period sec3 indicates a period when the blood sugar level is in equilibrium at the peak value. The falling period sec4 indicates a period from when the blood sugar level starts falling from the peak value to when the blood sugar level reaches a reference value. The first predictive blood sugar level calculating unit 222 calculates blood sugar level change curves for each of the plurality of periods. The first predictive blood sugar level calculating unit 222 calculates the first predictive blood sugar level change curve by combining each of the blood sugar level change curves of the plurality of periods.

First, a method of calculating the blood sugar level change curve for the delay period sec1 will be described. The first predictive blood sugar level calculating unit 222 calculates a blood sugar level change curve satisfying the following conditions (a1) to (a3) for the delay period sec1. (a1) The beginning of the delay period sec1 is a point in time when the meal starts. (a2) The ending of the delay period sec1 is a point in time when a delay time d1 has elapsed since the start of the meal. (a3) The delay period sec1 keeps a blood sugar level c1 at the start of the meal. A fixed value is used as the delay time d1. The delay time d1 is stored in advance in a recording medium such a memory of the predictive blood sugar level calculating device 100. For example, “15 (minutes)” is used as the delay time d1. A reference value of the blood sugar level of the user, an actually measured value of the blood sugar level of the user at the corresponding time (when the blood sugar level at the corresponding time is being measured), or a predictive value of the blood sugar level of the user at the corresponding time (when the blood sugar level at the corresponding time has been already predicted) is used as the blood sugar level c1 at the start of the meal.

Next, a method of calculating the blood sugar level change curve for the rising period sec2 will be described. The first predictive blood sugar level calculating unit 222 calculates a blood sugar level change curve satisfying the following conditions (b1) to (b3) for the rising period sec2. (b1) The beginning of the rising period sec2 is the ending of the delay period sec1. (b2) The ending of the rising period sec2 is a point in time when the blood sugar level reaches a sum value of the blood sugar level c1 at the start of the meal and a rising value h1 of the blood sugar level. (b3) For the rising period sec2, the blood sugar level rises with a slope sl1 when the blood sugar level is rising. For example, the first predictive blood sugar level calculating unit 222 calculates the rising value h1 of the blood sugar level using the following numerical formula (1). The first predictive blood sugar level calculating unit 222 calculates the slope sl1 when the blood sugar level is rising using the following numerical formula (2).

h1=T×GII×sm×ib×l1 (1)

sl1=T×GII×m1 (2)

In the numerical formulas (1) and (2), T, GII, sm, ib, l1, and m1 indicate the meal information about the meal of the user. T indicates a sugar mass. A variable value is used as the sugar mass T. For example, the first predictive blood sugar level calculating unit 222 extracts the sugar mass T from the meal information acquired by the meal information acquiring unit 202. The first predictive blood sugar level calculating unit 222 may calculate the sugar mass T on the basis of the meal information acquired by the meal information acquiring unit 202.

In the numerical formulas (1) and (2), GII indicates a GI value. A variable value is used as the GI value GII. For example, the first predictive blood sugar level calculating unit 222 extracts the GI value GII from the meal information acquired by the meal information acquiring unit 202. For example, “1”, “2”, or “3” is used as the GI value GII. As the GI value GII gets larger, it means that the GI value is higher. A fixed value may be used as the GI value GII.

In the numerical formula (1), sm indicates a second-meal effect value. A variable value is used as the second-meal effect value sm. A value of 0 to 1 is used as the second-meal effect value sm. As the second-meal effect value sm gets larger, it means that a second-meal effect is larger. The first predictive blood sugar level calculating unit 222 determines the second-meal effect sm with reference to a second-meal effect value determining table 232. The first predictive blood sugar level calculating unit 222 may acquire the second-meal effect value sm from an external device. A fixed value may be used as the second-meal effect value sm.

In the numerical formula (1), ib indicates an insulin secretion amount. A fixed value is used as the insulin secretion amount ib. For example, “1.0” is used as the insulin secretion amount ib. The insulin secretion amount ib is stored in advance in a recording medium such as the memory of the predictive blood sugar level calculating device 100. A variable value may be used as the insulin secretion amount ib. For example, the insulin secretion amount ib may vary according to each user. The insulin secretion amount ib may vary according to each attribute of users. The attributes of the users indicate, for example, age, sex, height, and weight. In such a case, the first predictive blood sugar level calculating unit 222 may acquire the insulin secretion amount ib from an external device.

In the numerical formula (1), l1 indicates a coefficient. A fixed value is used as the coefficient l1. For example, “0.2” is used as the coefficient l1. The coefficient l1 is stored in advance in a recording medium such as the memory of the predictive blood sugar level calculating device 100. A variable value may be used as the coefficient l1. For example, the coefficient l1 may vary according to each user. The coefficient l1 may vary according to each attribute of users. In such a case, the first predictive blood sugar level calculating unit 222 may acquire the coefficient l1 from an external device.

In the numerical formula (2), m1 indicates a coefficient. A fixed value is used as the coefficient m1. The coefficient m1 is stored in advance in a recording medium such as the memory of the predictive blood sugar level calculating device 100. A variable value may be used as the coefficient m1. For example, the coefficient m1 may vary according to each user. The coefficient m1 may vary according to each attribute of users. In such a case, the first predictive blood sugar level calculating unit 222 may acquire the coefficient m1 from an external device.

Next, a method of calculating the blood sugar level change curve for the equilibrium period sec3 will be described. The first predictive blood sugar level calculating unit 222 calculates a blood sugar level change curve satisfying the following conditions (c1) to (c3) for the equilibrium period sec3. (c1) The beginning of the equilibrium period sec3 is the ending of the rising period sec2. (c2) The ending of the equilibrium period sec3 is the point in time when an equilibrium time e1 has elapsed since the beginning of the equilibrium period sec3. (c3) The equilibrium period sec3 keeps a sum value of the blood sugar level c1 at the start of the meal and the rising value h1 of the blood sugar level. For example, the first predictive blood sugar level calculating unit 222 calculates the equilibrium time e1 using the following numerical formula (3).

e1=(T×GII×n1)/sm (3)

In the numerical formula (3), T, GII, n1, and sm are meal information about the meal of the user. T, GII, and sm are the meal information about the meal of the user, and are the same as the numerical formulas (1) and (2). In addition, n1 indicates a coefficient. A fixed value is used as the coefficient n1. The coefficient n1 is stored in advance in a recording medium such as the memory of the predictive blood sugar level calculating device 100. A variable value may be used as the coefficient n1. For example, the coefficient n1 may vary according to each user. The coefficient n1 may vary according to each attribute of users. In such a case, the first predictive blood sugar level calculating unit 222 may acquire the coefficient n1 from an external device.

Next, a method of calculating the blood sugar level change curve for the falling period sec4 will be described. The first predictive blood sugar level calculating unit 222 calculates a blood sugar level change curve satisfying the following conditions (d1) to (d3) for the falling period sec4. (d1) The beginning of the falling period sec4 is the ending of the equilibrium period sec3. (d2) The ending of the falling period sec4 is a point in time when the blood sugar level reaches the blood sugar level c1 at the start of the meal. (d3) For the falling period sec4, the blood sugar level falls with a slope sl2 when the blood sugar level is falling. For example, the first predictive blood sugar level calculating unit 222 calculates the slope sl2 when the blood sugar level is falling using the following numerical formula (4).

sl2=T×GII×p1 (4)

In the numerical formula (4), T, GII, and p1 are meal information about the meal of the user. T and GII are the same as the numerical formulas (1) and (2). In addition, p1 indicates a coefficient. A fixed value is used as the coefficient p1. The coefficient p1 is stored in advance in a recording medium such as the memory of the predictive blood sugar level calculating device 100. A variable value may be used as the coefficient p1. For example, the coefficient p1 may vary according to each user. The coefficient p1 may vary according to each attribute of users. In such a case, the first predictive blood sugar level calculating unit 222 may acquire the coefficient p1 from an external device.

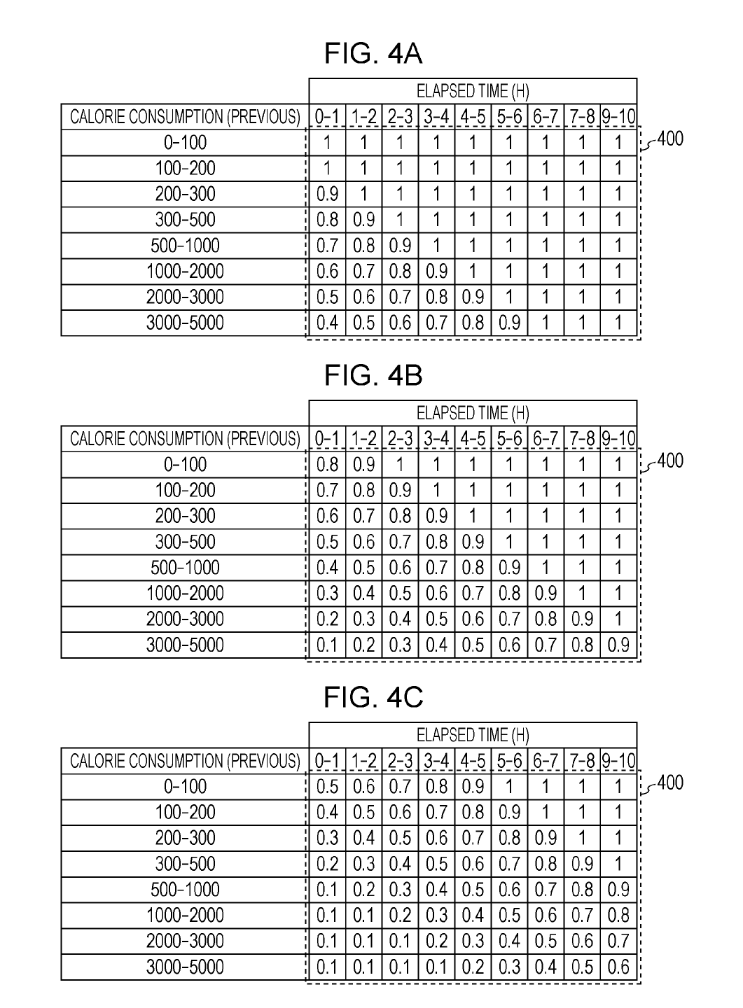

FIG. 4A, FIG. 4B, and FIG. 4C show the second-meal effect value determining tables 232. The second-meal effect value determining tables 232 shown in FIG. 4A, FIG. 4B, and FIG. 4C have an item “calorie intake (previous)”, an item “elapsed time”, and a second-meal effect value setting section 400. In the item “calorie intake (previous)”, a value is set by multiplying the sugar mass in the previous meal by the GI value in the previous meal. In the item “elapsed time”, an elapsed time from the previous meal to the start of the present meal is set. In the second-meal effect value setting section 400, a second-meal effect value is set which is uniquely determined by the value of the item “calorie intake (previous)” and the value of the item “elapsed time”.

The predictive blood sugar level calculating device 100 has a plurality of second-meal effect value determining tables 232 in which the second-meal effect values vary according to comparative relation between the previous meal amount and the present meal amount. For example, in the example shown in FIG. 4A, FIG. 4B, and FIG. 4C, the second-meal effect value determining tables 232A to 232C are provided. The second-meal effect value determining table 232A is used when the present meal amount is larger than the previous meal amount and the first predictive blood sugar level calculating unit 222 determines the second-meal effect value. The second-meal effect value determining table 232B is used when the present meal amount is substantially equal to the previous meal amount and the first predictive blood sugar level calculating unit 222 determines the second-meal effect value. The second-meal effect value determining table 232C is used when the present meal amount is smaller than the previous meal amount and the first predictive blood sugar level calculating unit 222 determines the second-meal effect value. For example, the first predictive blood sugar level calculating unit 222 quantifies the comparative relation between the previous meal amount and the present meal amount using the following numerical formula (5).

(T′×GII′)/(T″×GII″) (5)

In the numerical formula (5), T′ indicates a sugar mass of the previous meal. GII′ indicates a GI value of the previous meal. T″ indicates a sugar mass of the present meal. GII″ indicates a GI value of the present meal. When the value calculated by the numerical formula (5) is “0.3 to 0.7”, the first predictive blood sugar level calculating unit 222 determines that “the present meal amount is larger than the previous meal amount”. When the value calculated by the numerical formula (5) is “0.7 to 1.5”, the first predictive blood sugar level calculating unit 222 determines that “the present meal amount is substantially equal to the previous meal amount”. When the value calculated by the numerical formula (5) is “larger than 1.5”, the first predictive blood sugar level calculating unit 222 determines that “the present meal amount is smaller than the previous meal amount”.

In the second-meal effect value determining table 232, as the present meal amount gets smaller with respect to the previous meal amount, a smaller second-meal effect value is set. Accordingly, the first predictive blood sugar level calculating unit 222 determines that the second-meal effect value is smaller as the present meal amount gets smaller with respect to the previous meal amount. In the second-meal effect value determining table 232, as the previous meal amount gets larger, a smaller second-meal effect value is set. Accordingly, the first predictive blood sugar level calculating unit 222 determines that the second-meal effect value is smaller as the previous meal amount gets larger. In the second-meal effect value determining table 232, as the elapsed time from the previous meal to the start of the present meal gets shorter, a smaller second-meal effect value is set. Accordingly, the first predictive blood sugar level calculating unit 222 determines that the second-meal effect value is smaller as the elapsed time from the previous meal to the start of the present meal gets shorter.

As described with reference to FIG. 3, FIG. 4A, FIG. 4B, and FIG. 4C, the first predictive blood sugar level calculating unit 222 calculates the first predictive blood sugar level change curve, considering the sugar mass, the GI value, the second-meal effect, and the insulin secretion amount. Accordingly, the first predictive blood sugar level calculating unit 222 can calculate the first predictive blood sugar level change curve with high precision and with a small error from the actual change in the blood sugar level occurring in the human body. The first predictive blood sugar level calculating unit 222 divides a period into a plurality of periods and calculates the first predictive blood sugar level change curve using the simple numerical formulas for the plurality of periods. Accordingly, the first predictive blood sugar level calculating unit 222 can efficiently calculate the first predictive blood sugar level change curve.

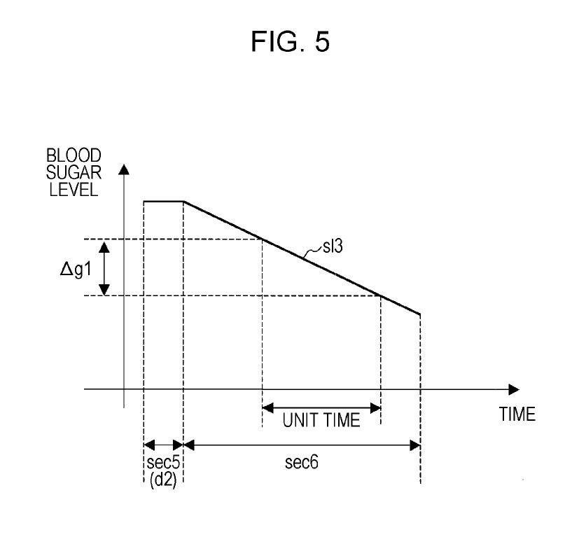

FIG. 5 shows a process of calculating the second predictive blood sugar level change curve. The second predictive blood sugar level change curve includes a delay period sec5, and a falling period sec6. The delay period sec5 indicates a period from when exercise starts to when the blood sugar level starts falling. The falling period sec6 indicates a period when the blood sugar level falls continuously. The second predictive blood sugar level calculating unit 224 calculates blood sugar level change curves for each of the plurality of periods. The second predictive blood sugar level calculating unit 224 calculates the second predictive blood sugar level change curve by combining the blood sugar level change curves of each of the plurality of periods. The second predictive blood sugar level calculating unit 224 calculates the second predictive blood sugar level change curve without the delay period sec5 for the rest time (non-exercise time).

First, a method of calculating the blood sugar level change curve for the delay period sec5 will be described. The second predictive blood sugar level calculating unit 224 calculates a blood sugar level change curve satisfying the following conditions (e1) to (e3) for the delay period sec5. (e1) The beginning of the delay period sec5 is a point in time when the exercise starts. (e2) The ending of the delay period sec5 is a point in time when a delay time d2 has elapsed since when the exercise started. (e3) The delay period sec5 keeps a blood sugar level c1 at the start of the exercise. A fixed value is used as the delay time d2. The delay time d2 is stored in advance in a recording medium such as the memory of the predictive blood sugar level calculating device 100. For example, “2 (minutes)” is used as the delay time d2.

Next, a method of calculating the blood sugar level change curve for the falling period sec6 will be described. The second predictive blood sugar level calculating unit 224 calculates a blood sugar level change curve satisfying the following conditions (f1) to (f2) for the falling period sec6. (f1) The beginning of the falling period sec6 is the ending of the delay period sec5 when the delay period sec5 is provided. (f2) For the falling period sec6, the blood sugar level decreases with the elapsing of time. In this case, a decrease amount of the blood sugar level per unit of time is Δg1. For example, the second predictive blood sugar level calculating unit 224 calculates the decrease amount Δg1 of the blood sugar level per unit of time using the following numerical formula (6).

Δg1=C×ib×s13 (6)

In the numerical formula (6), C, ib, and sl3 are calorie consumption information about the calorie consumption of the user. Herein, ib is the same as the numerical formulas (1) and (2). C indicates calorie consumption. A variable value is used as the calorie consumption C. For example, the second predictive blood sugar level calculating unit 224 extracts the calorie consumption C from the calorie consumption information acquired by the calorie consumption information acquiring unit 204.

The second predictive blood sugar level calculating unit 224 may use calorie consumption information according to an action of the user. An example of the action of the user includes exercise, rest, drinking, and sleeping. For example, when the calorie consumption information acquired by the calorie consumption information acquiring unit 204 includes information indicating the action of the user, the second predictive blood sugar level calculating unit 224 specifies the action of the user by the information indicating the action of the user. The second predictive blood sugar level calculating unit 224 may determine the action of the user according to a method other than the above-described method. For example, the second predictive blood sugar level calculating unit 224 may specify the action of the user on the basis of the value of the calorie consumption included in the calorie consumption information acquired by the calorie consumption information acquiring unit 204 and the change thereof. When the pulse information acquired by the pulse information acquiring unit 206 includes the information indicating the action of the user, the second predictive blood sugar level calculating unit 224 may specify the action of the user by the information indicating the action of the user. The second predictive blood sugar level calculating unit 224 may specify the action of the user on the basis of the pulse value included in the pulse information acquired by the pulse information acquiring unit 206 and the change thereof. The second blood sugar level calculating unit 224 may determine the drinking time from the drinking information acquired by the drinking information acquiring unit 203.

For example, the second predictive blood sugar level calculating unit 224 uses the calorie consumption information acquired from the activity meter 114 using the calorie consumption information acquiring unit 204 for the exercising time. The second predictive blood sugar level calculating unit 224 uses the calorie consumption information acquired from the pulsimeter 116 using the calorie consumption information acquiring unit 204 for the rest time. The second predictive blood sugar level calculating unit 224 may use the calorie consumption information acquired from the pulsimeter 116 using the calorie consumption information acquiring unit 204 for the exercising time.

For the period when the calorie consumption information measured by either the activity meter 114 or the pulsimeter 116 is not acquired for any reason, the second predictive blood sugar level calculating unit 224 may use calorie consumption information measured by the other one out of the activity meter 114 or the pulsimeter 116. For the period when the calorie consumption information measured by at least one of the activity meter 114 and the pulsimeter 116 is not acquired for any reason, the second predictive blood sugar level calculating unit 224 may use 0 or a predetermined fixed value as the calorie consumption C. For the period when normal calorie consumption information cannot be acquired due to failure or the like of at least one of the activity meter 114 and the pulsimeter 116, the second predictive blood sugar level calculating unit 224 may use the calorie consumption information of a different period when the normal calorie consumption information can be acquired. In this case, the second predictive blood sugar level calculating unit 224 may use the calorie consumption information of the period when the normal calorie consumption information can be acquired where the action of the user is the same as the period when the normal calorie consumption information cannot be acquired.

In the numerical formula (6), sl3 indicates a coefficient. A variable value is used as the coefficient sl3. For example, one of “−1.1”, “−0.6”, “−0.3”, “−0.2”, and “−0.1” is selective used as the coefficient sl3. For example, the second predictive blood sugar level calculating unit 224 uses “−1.1” as the coefficient sl3 when the blood sugar level is equal to or higher than “300 (mg/dL)”. The second predictive blood sugar level calculating unit 224 uses “−0.6” as the coefficient sl3 when the blood sugar level is “200 to 300 (mg/dL)”. The second predictive blood sugar level calculating unit 224 uses “−0.3” as the coefficient sl3 when the blood sugar level is “150 to 200 (mg/dL)”. The second predictive blood sugar level calculating unit 224 uses “−0.2” as the coefficient sl3 when the blood sugar level is “100 to 150 (mg/dL)”. The second predictive blood sugar level calculating unit 224 uses “−0.1” as the coefficient s13 when the blood sugar level is lower than “100 (mg/dL)”.

The coefficient sl3 is stored in advance in a recording medium such as the memory of the predictive blood sugar level calculating device 100. For example, the coefficient sl3 may vary according to each user. The coefficient sl3 may vary according to each attributes of user. The second predictive blood sugar level calculating unit 224 may acquire the coefficient s13 from an external device.

For example, when the calorie consumption C per unit of time (1 second) is “109 (kcal)”, the insulin secretion amount ib is “1.0”, and the coefficient sl3 is “−1.1”, the second predictive blood sugar level calculating unit 224 calculates about “−120 (mg/dL/sec)” as the decrease amount Δg1 of the blood sugar level per unit of time (1 second) from the numerical formula (6). As described above, the second predictive blood sugar level calculating unit 224 calculates the second predictive blood sugar level change curve in which the blood sugar level decreases with the elapsing of time. Particularly, the second blood sugar level calculating unit 224 calculates the second predictive blood sugar level change curve in which the decrease amount of the blood sugar level per unit of time increases as the calorie consumption when exercising gets larger, using the numerical formula (6). The second predictive blood sugar level calculating unit 224 calculates the second predictive blood sugar level change curve in which the decrease amount of the blood sugar level per unit of time increases as the blood sugar level at the start of exercise is higher. The second predictive blood sugar level calculating unit 224 may calculate the second predictive blood sugar level change curve using numerical formula other than numerical formula (5) as long as the blood sugar level in the second predictive blood sugar level change curve decreases with the elapsing of time.

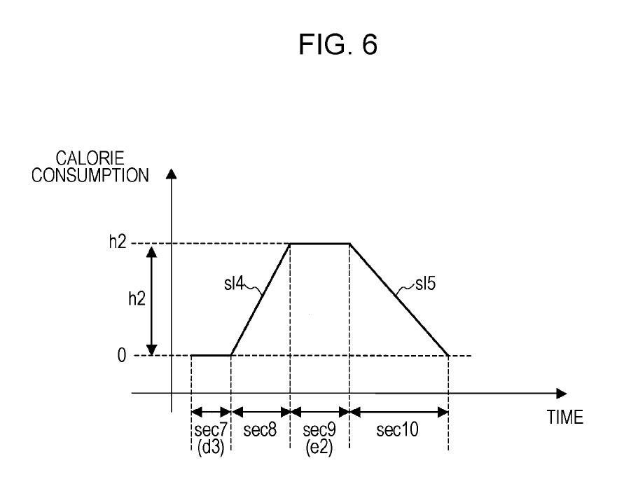

FIG. 6 shows a process of calculating a predictive calorie consumption change curve. When drinking, the second predictive blood sugar level calculating unit 224 calculates the predictive calorie consumption change curve indicating change in a predictive value of the calorie consumption in a time series by performing the process described in FIG. 6 using the drinking information acquired by the drinking information acquiring unit 203. The second predictive blood sugar level calculating unit 224 calculates the second predictive blood sugar level change curve when drinking by performing the process described in FIG. 5 using the calculated predictive calorie consumption change curve instead of the calorie consumption information acquired by the calorie consumption information acquiring unit 204. Hereinafter, the process of calculating the predictive calorie consumption change curve performed by the second predictive blood sugar level calculating unit 224 will be described.

The predictive calorie consumption change curve includes a delay period sec7, a rising period sec8, an equilibrium period sec9, and a falling period sec10. The delay period sec7 indicates a period from when drinking starts to when the calorie consumption starts rising. The rising period sec8 indicates a period from when the calorie consumption starts rising to when the calorie consumption reaches a peak value. The equilibrium period sec9 indicates a period when the calorie consumption is in equilibrium at the peak value. The falling period sec10 indicates a period from when the calorie consumption starts falling from the peak value to when the calorie consumption reaches a reference value. The second predictive blood sugar level calculating unit 224 calculates predictive calorie consumption change curves for each of the plurality of periods. The second predictive blood sugar level calculating unit 224 calculates the final predictive calorie consumption change curve by combining each of the predictive calorie consumption change curves of the plurality of periods.

First, a method of calculating the predictive calorie consumption change curve for the delay period sec7 will be described. The second predictive blood sugar level calculating unit 224 calculates a predictive calorie consumption change curve satisfying the following conditions (g1) to (g3) for the delay period sec7. (g1) The beginning of the delay period sec7 is a point in time when the drinking starts. (g2) The ending of the delay period sec7 is a point in time when a delay time d3 has elapsed since the start of the drinking. (g3) The delay period sec7 keeps a calorie consumption amount (i.e., 0) at the start of the drinking. A fixed value is used as the delay time d3. The delay time d3 is stored in advance in a recording medium such a memory of the predictive blood sugar level calculating device 100. For example, “15 (minutes)” is used as the delay time d3.

Next, a method of calculating the predictive calorie consumption change curve for the rising period sec8 will be described. The second predictive blood sugar level calculating unit 224 calculates a predictive calorie consumption change curve satisfying the following conditions (h1) to (h3) for the rising period sec8. (h1) The beginning of the rising period sec8 is the ending of the delay period sec7. (h2) The ending of the rising period sec8 is a point in time when the calorie consumption reaches a peak value h2. (h3) For the rising period sec8, the calorie consumption rises with a slope s14 when the calorie consumption is rising. For example, the second predictive blood sugar level calculating unit 224 calculates the rising peak value h2 of the calorie consumption using the following numerical formula (7). The second predictive blood sugar level calculating unit 224 calculates the slope s14 when the calorie consumption is rising using the following numerical formula (8).

h2=a1×dif×taicho×12 (7)

s14=a1×dif×taicho×m2 (8)

In the numerical formulas (7) and (8), a1, dif, taicho, l2, and m2 indicate drinking information about the drinking of the user. Herein, a1 indicates an ethanol amount. A variable value is used as the ethanol amount a1. For example, the second predictive blood sugar level calculating unit 224 extracts the ethanol amount a1 from the drinking information acquired by the drinking information acquiring unit 203. When the ethanol amount a1 is not represented in the drinking information, the second predictive blood sugar level calculating unit 224 may calculate the ethanol amount a1 on the basis of the drinking information acquired by the drinking information acquiring unit 203.

In the numerical formulas (7) and (8), dif indicates resistance against alcohol. A variable value is used as the resistance against alcohol dif. For example, the resistance against alcohol dif varies according to each user. For example, the second predictive blood sugar level calculating unit 224 extracts the resistance against alcohol dif from the body characteristic information acquired by the body characteristic information acquiring unit 208. For example, “1.0” is used as a reference value for the resistance against alcohol dif. As the resistance against alcohol dif gets larger, it means that the resistance against alcohol is lower and calorie consumption is higher. A fixed value may be used as the resistance against alcohol dif.

In the numerical formulas (7) and (8), taicho indicates physical condition. A variable value is used as the physical condition taicho. For example, a value of 1 to 5 is used as the physical condition taicho. As the numerical value of the physical condition taicho gets larger, it means that the physical condition is better. The second predictive blood sugar level calculating unit 224 determines the physical condition taicho with reference to a physical condition determining table 234. The second predictive blood sugar level calculating unit 224 may acquire the physical condition taicho from an external device. A fixed value may be used as the physical condition taicho.

In the numerical formula (7), 12 indicates a coefficient. A fixed value is used as the coefficient 12. For example, “0.2” is used as the coefficient 12. The coefficient 12 is stored in advance in a recording medium such as the memory of the predictive blood sugar level calculating device 100. A variable value may be used as the coefficient 12. For example, the coefficient 12 may vary according to each user. The coefficient 12 may vary according to each attribute of users. In such a case, the second predictive blood sugar level calculating unit 224 may acquire the coefficient 12 from an external device.

In the numerical formula (8), m2 indicates a coefficient. A fixed value is used as the coefficient m2. The coefficient m2 is stored in advance in a recording medium such as the memory of the predictive blood sugar level calculating device 100. A variable value may be used as the coefficient m2. For example, the coefficient m2 may vary according to each user. The coefficient m2 may vary according to each attribute of users. In such a case, the second predictive blood sugar level calculating unit 224 may acquire the coefficient m2 from an external device.

Next, a method of calculating the predictive calorie consumption change curve for the equilibrium period sec9 will be described. The second predictive blood sugar level calculating unit 224 calculates a predictive calorie consumption change curve satisfying the following conditions (i1) to (i3) for the equilibrium period sec9. (i1) The beginning of the equilibrium period sec9 is the ending of the rising period sec8. (i2) The ending of the equilibrium period sec9 is the point in time when an equilibrium time e2 has elapsed since the beginning of the equilibrium period sec9. (i3) The equilibrium period sec9 keeps the peak value h2 of the calorie consumption. For example, the second predictive blood sugar level calculating unit 224 calculates the equilibrium time e2 using the following numerical formula (9).

e2=a1×dif×taicho×n2 (9)

In the numerical formula (9), a1, dif, taicho, and n2 are drinking information, and a1, dif, and taicho are the same as the numerical formulas (7) and (8). In addition, n2 indicates a coefficient. A fixed value is used as the coefficient n2. The coefficient n2 is stored in advance in a recording medium such as the memory of the predictive blood sugar level calculating device 100. A variable value may be used as the coefficient n2. For example, the coefficient n2 may vary according to each user. The coefficient n2 may vary according to each attribute of users. In such a case, the second predictive blood sugar level calculating unit 224 may acquire the coefficient n2 from an external device.

A method of calculating the predictive calorie consumption change curve for the falling period sec10 will be described. The second predictive blood sugar level calculating unit 224 calculates a predictive calorie consumption change curve satisfying the following conditions (j1) to (j3) for the falling period sec10. (j1) The beginning of the falling period sec10 is the ending of the equilibrium period sec9. (j2) The ending of the falling period sec10 is a point in time when the calorie consumption reaches the calorie consumption amount (i.e., 0) at the start of the drinking. (j3) For the falling period sec10, the calorie consumption falls with a slope s15 when the calorie consumption is falling. For example, the second predictive blood sugar level calculating unit 224 calculates the slope s15 when the calorie consumption is falling using the following numerical formula (10).

s15=a1×dif×taicho×p2 (10)

In the numerical formula (10), a1, dif, taicho, and p2 are drinking information, and a1, dif, and taicho are the same as the numerical formulas (7) and (8). In the numerical formula (10), p2 indicates a coefficient. A fixed value is used as the coefficient p2. The coefficient p2 is stored in advance in a recording medium such as the memory of the predictive blood sugar level calculating device 100. A variable value may be used as the coefficient p2. For example, the coefficient p2 may vary according to each user. The coefficient p2 may vary according to each attribute of users. In such a case, the second predictive blood sugar level calculating unit 224 may acquire the coefficient p2 from an external device.

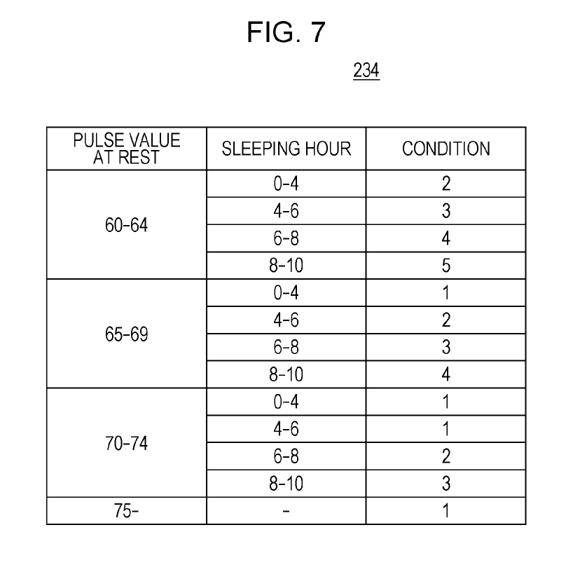

FIG. 7 shows the physical condition determining tables 234. The physical condition determining table 234 shown in FIG. 7 has an item “pulse value at rest”, an item “sleeping duration”, and an item “physical condition”. In the item “pulse value at rest”, a value indicating a pulse value at rest is set. In the item “sleeping duration”, a value indicating a sleeping duration is set. In the item “physical condition”, a value indicating a physical condition determined by “pulse value at rest” and “sleeping duration” is set.

In the physical condition determining table 234, a value “0 to 4 (hours)” for the item “sleeping duration” corresponding to a value “60 to 64” for the item “pulse value at rest” corresponds to “2” as the item “physical condition”. A value “4 to 6 (hours)” for the item “sleeping duration” corresponding to a value “60 to 64” for the item “pulse value at rest” corresponds to “3” as the item “physical condition”. As described above, in the physical condition determining table 234, as the sleeping duration gets longer, a better physical condition is set. Accordingly, the second predictive blood sugar level calculating unit 224 determines that the physical condition is better as the sleeping duration gets longer with reference to the physical condition determining table 234.

In the physical condition determining table 234, a value “0 to 4 (hours)” for the item “sleeping duration” corresponding to a value “60 to 64” for the item “pulse value at rest” corresponds to “2” as the item “physical condition”. A value “0 to 4 (hours)” for the item “sleeping duration” corresponding to a value “65 to 69” for the item “pulse value at rest” corresponds to “1” as the item “physical condition”. As described above, in the physical condition determining table 234, as the value of the pulse value get larger, a worse physical condition is set. Accordingly, the second predictive blood sugar level calculating unit 224 determines that the physical condition is worse as the value of the pulse value at rest gets larger with reference to the physical condition determining table 234.

The second predictive blood sugar level calculating unit 224 determines the pulse value at rest on the basis of the pulse information acquired by the pulse information acquiring unit 206. The second predictive blood sugar level calculating unit 224 specifies a period satisfying the following conditions (k1) to (k5) as a calculation reference period of the pulse value at rest. An average value of the pulse value for 30 minutes from the time after 15 minutes from the beginning of the calculation reference period is determined as the pulse value at rest. (k1) It is a non-drinking time. (k2) A predetermined time (e.g., 1 hour) has elapsed since the meal ended. (k3) A predetermined time has elapsed since the exercise ended. (k4) It is possible to determine that it is the rest time using information acquired from an external device. (k5) The conditions (k1) to (k4) are satisfied continuously for 30 minutes or more.

The second predictive blood sugar level calculating unit 224 determines the sleeping duration using information acquired from an external device. For example, when sleeping duration is represented in the calorie consumption information acquired by the calorie consumption information acquiring unit 204, the second predictive blood sugar level calculating unit 224 may determine the sleeping duration from the calorie consumption information. The second predictive blood sugar level calculating unit 224 may determine the sleeping duration from information other than the information described above.

As described with reference to FIG. 5, FIG. 6, and FIG. 7, the second predictive blood sugar level calculating unit 224 calculates the second predictive blood sugar level change curve, considering the calorie consumption and the insulin secretion amount and using the simple calculation formulas. Accordingly, the second predictive blood sugar level calculating unit 224 can efficiently calculate the second predictive blood sugar level change curve with high precision and with a small error from the actual change in the blood sugar level occurring in the human body. For the drinking time, the second predictive blood sugar level calculating unit 224 calculates the predictive calorie consumption change curve and calculates the second predictive blood sugar level change curve on the basis of the predictive calorie consumption change curve. In this case, the second predictive blood sugar level calculating unit 224 calculates the predictive calorie consumption change curve, considering the ethanol amount, the resistance against alcohol, and the physical condition. Accordingly, the second predictive blood sugar level calculating unit 224 can calculate the predictive calorie consumption change curve with high precision and with a small error from the actual change in the calorie consumption occurring in the human body, and thus can calculate the second predictive blood sugar level change curve with high precision. The second blood sugar level calculating unit 224 divides a period into a plurality of periods and calculates the predictive calorie consumption change curve for the plurality of periods using the simple calculation formulas. Accordingly, the second predictive blood sugar level calculating unit 224 can efficiently calculate the predictive calorie consumption change curve and thus can efficiently calculate the second predictive blood sugar level change curve. In addition, the second predictive blood sugar level calculating unit 224 may calculate the second predictive blood sugar level change curve when drinking by performing the process described with reference to FIG. 5 using the calorie consumption information acquired by the calorie consumption information acquiring unit 204.

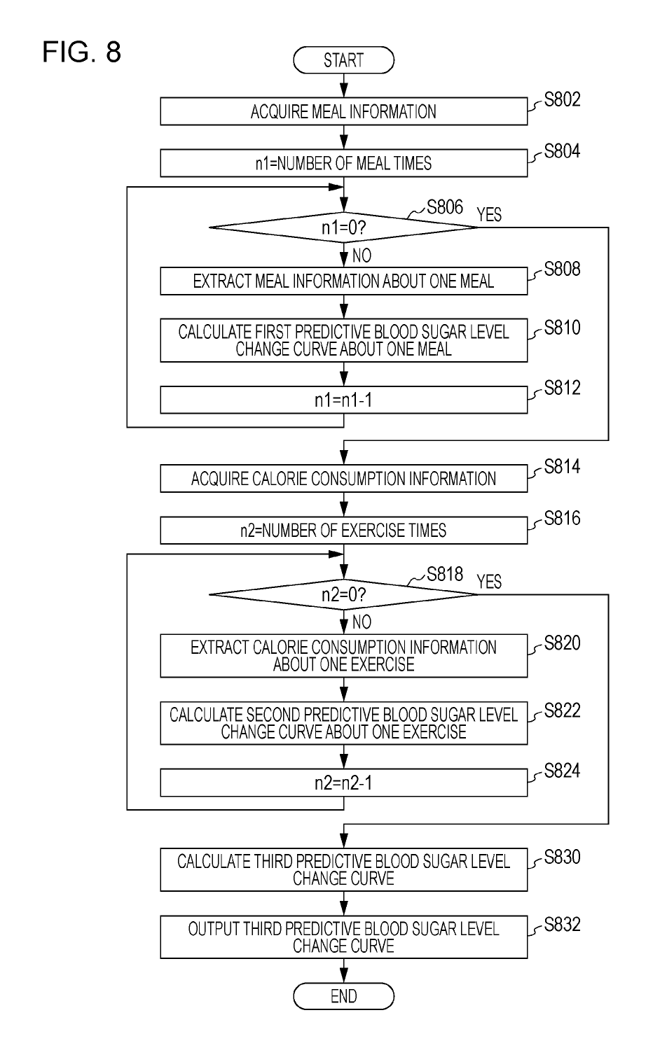

FIG. 8 shows a process sequence of the predictive blood sugar level calculating device 100 according to the first embodiment. First, the meal information acquiring unit 202 acquires the meal information (Step S802). Then, the first predictive blood sugar level calculating unit 222 stores the number of meal times indicated in the meal information acquired in Step S802 in the variable n1 (Step S804).

Then, the first predictive blood sugar level calculating unit 222 determines whether or not the value of the variable n1 is 0 (Step S806). In Step S806, when it is determined that the value of the variable n1 is 0 (Step S806: Yes), the predictive blood sugar level calculating device 100 proceeds the process to Step S814. In Step S806, when it is determined that the value of the variable n1 is not 0 (Step S806: No), the first predictive blood sugar level calculating unit 222 extracts the meal information about one meal from the meal information acquired in Step S802 (Step S808). The first predictive blood sugar level calculating unit 222 calculates the first predictive blood sugar level change curve about one meal on the basis of the meal information about one meal extracted in Step S808 (Step S810). The first predictive blood sugar level calculating unit 222 stores a value, which is obtained by subtracting 1 from the value stored in the variable n1, in the variable n1 (Step S812), and returns the process to Step S806. The first predictive blood sugar level calculating unit 222 repeatedly performs Step S806 to Step 812 until the first predictive blood sugar level change curve is calculated for every meal.

In Step S814, the calorie consumption information acquiring unit 204 acquires the calorie consumption information (Step S814). Then, the second predictive blood sugar level calculating unit 224 stores the number of exercise times indicated in the calorie consumption information acquired in Step S814 in the variable n2 (Step S816). Then, the second predictive blood sugar level calculating unit 224 determines whether or not the value of the variable n2 is 0 (Step S818). In Step S818, when it is determined that the value of the variable n2 is 0 (Step S818: Yes), the predictive blood sugar level calculating device 100 proceeds the process to Step S830. In Step S818, when it is determined that the value of the variable n2 is not 0 (Step S818: No), the second predictive blood sugar level calculating unit 224 extracts the calorie consumption information about one exercise from the calorie consumption information acquired in Step S802 (Step S820). The second predictive blood sugar level calculating unit 224 calculates the second predictive blood sugar level change curve about the one exercise on the basis of the calorie consumption information about the one exercise extracted in Step S820 (Step S822). The second predictive blood sugar level calculating unit 224 stores a value, which is obtained by subtracting 1 from the value stored in the variable n2, in the variable n2 (Step S824), and returns the process to Step S818. The second predictive blood sugar level calculating unit 224 repeatedly performs Step S818 to Step S824 until the second predictive blood sugar level change curve is calculated for every exercise.

In Step S830, the third predictive blood sugar level calculating unit 230 calculates the third predictive blood sugar level change curve based on the meal intake of the user and the calorie consumption of the user by combining the first predictive blood sugar level change curve calculated in Step S810 and the second predictive blood sugar level change curve calculated in Step S822 (Step S830). The output unit 240 outputs the third predictive blood sugar level change curve calculated in Step S830 (Step S832), and the predictive blood sugar level calculating device 100 ends a series of processes. The predictive blood sugar level calculating device 100 of the embodiment performs the calculation process of the first predictive blood sugar level change curve described in Step S802 to Step 812, in units of seconds or minutes, for example, in 4 second units. Similarly, the calculation process of the second predictive blood sugar level change curve described in Step S814 to Step S824 is performed in units of seconds or minutes, for example, in 4 second units. The calculation process and the output process of the third predictive blood sugar level change curve described in Step S830 to Step S832 are performed in units of seconds or minutes, for example, in 4 second units. As described above, it is possible to provide the latest predictive blood sugar level change curve to the user according to the blood sugar level changing every moment by providing the processing in units of seconds or minutes.

The predictive blood sugar level calculating device 100 periodically performs the process described with reference to FIG. 8. For example, the predictive blood sugar level calculating device 100 performs the process for each predetermined unit of time (e.g., 4 seconds), and calculates and outputs the third predictive blood sugar level change curve. Accordingly, the predictive blood sugar level calculating device 100 can continuously output the latest third predictive blood sugar level change curve always on the basis of the latest information.

The predictive blood sugar level calculating device 100 may perform the process at an arbitrary time designated by the user. The predictive blood sugar level calculating unit 100 may perform the process at a time when a predetermined event happens. The predictive blood sugar level calculating device 100 may perform the process at a time when it is detected that any information used to calculate the third predictive blood sugar level change curve is updated, for example, when the latest calorie consumption information is acquired, when the latest pulse information is acquired, when it is detected that the user takes the meal, when it is detected that the user drinks, when it is detected that the user takes exercise, or when it is detected that the action of the user changes.

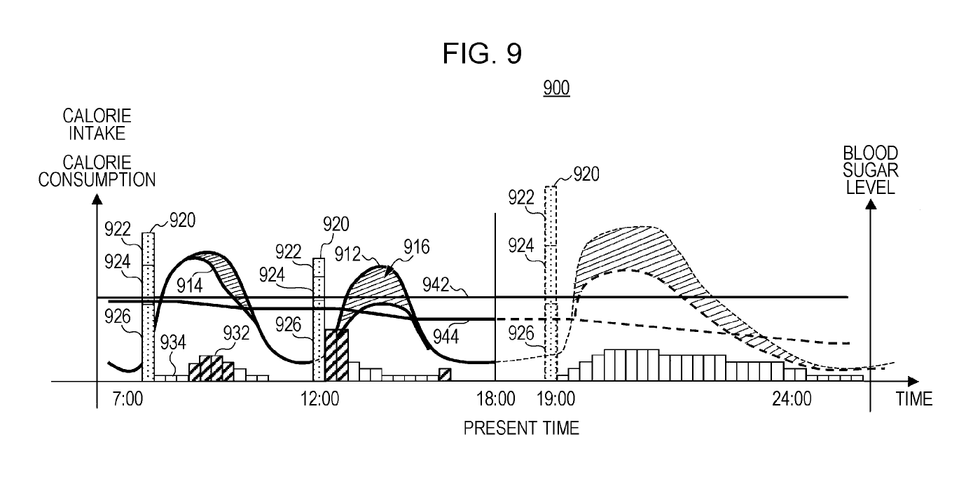

FIG. 9 shows the information output by the output unit 240. A graph 900 shown in FIG. 9 is the information output by the output unit 240 and shows the information displayed on the display device of the predictive blood sugar level calculating device 100. In the graph 900, a change curve 912 indicates the first predictive blood sugar level change curve calculated by the first predictive blood sugar level calculating unit 222. In the graph 900, a change curve 914 is the third predictive blood sugar level change curve calculated by the third predictive blood sugar level calculating unit 230, and indicates the third predictive blood sugar level change curve obtained by combining the first predictive blood sugar level change curve calculated by the first predictive blood sugar level calculating unit 222 and the second predictive blood sugar level change curve calculated by the second predictive blood sugar level calculating unit 224.

In the graph 900, an area 916 indicates an amount of difference between the change curve 914 and the change curve 912. That is, the area 916 indicates an amount of a blood sugar level reduced by the calorie consumption indicated by the second predictive blood sugar level change curve. In the graph 900, bars 920 indicate amounts of calorie intake. An area 922 of the bars 920 indicates protein mass. An area 924 indicates fat mass. An area 926 indicates sugar mass. In the graph 900, bars 932 indicate amounts of calorie consumption when exercising. Bars 934 indicate amounts of calorie consumption at rest. A change curve 942 indicates a transition of a predictive value of an integration value of the blood sugar level (or a predictive value of HbA1C) when the calorie consumption at rest is low. A change curve 944 indicates a transition of a predictive value of an integration value of the blood sugar level (or a predictive value of HbA1C) when the amount of the calorie consumption at rest has increased.

The predictive blood sugar level calculating device 100 may change the action (e.g., meal amount, exercise amount, etc.) of the user at an arbitrary point in time in the past in data or graph according to an instruction by the user. Accordingly, for example, the user can confirm how the third predictive blood sugar level change curve changes according to change in a past action. The predictive blood sugar level calculating device 100 may calculate the third predictive blood sugar level change curve for the present or for an arbitrary point in time in the future. In this case, the predictive blood sugar level calculating device 100 may change the action (e.g., meal amount, exercise amount, etc.) of the user at an arbitrary point in time in the future in data or graph according to an instruction by the user. Accordingly, for example, the user can confirm how the third predictive blood sugar level change curve changes according to change in a future action. The user can easily determine which actions in the past were preferable and which actions in the future are preferable to optimize the blood sugar level by utilizing such a function. The predictive blood sugar level calculating device 100 may further include a function of automatically performing such determination.

The predictive blood sugar level calculating system 10 according to the embodiment may be applied to a guidance system for diabetic patients. In this case, a doctor or a supervisor corresponding to the doctor can visibly show the diabetic patient the change in the blood sugar level, the calorie intake, the calorie consumption, and the like caused by the action such as the exercise and the meal of the diabetic patient, using the predictive blood sugar level calculating system 10. Since the predictive blood sugar level calculating system 10 can output the second predictive blood sugar level change curve with high precision, the doctor or the supervisor corresponding to the doctor can give proper advice to the diabetic patient using the predictive blood sugar level calculating system 10 even when they have a little experience and knowledge. In addition, since the predictive blood sugar level calculating system 10 can automatically output the third predictive blood sugar level change curve by giving it input parameters, the diabetic patient can by themselves determine proper action (when, what, how much) personally using the predictive blood sugar level calculating system 10, without depending on the doctor or the supervisor corresponding to the doctor.

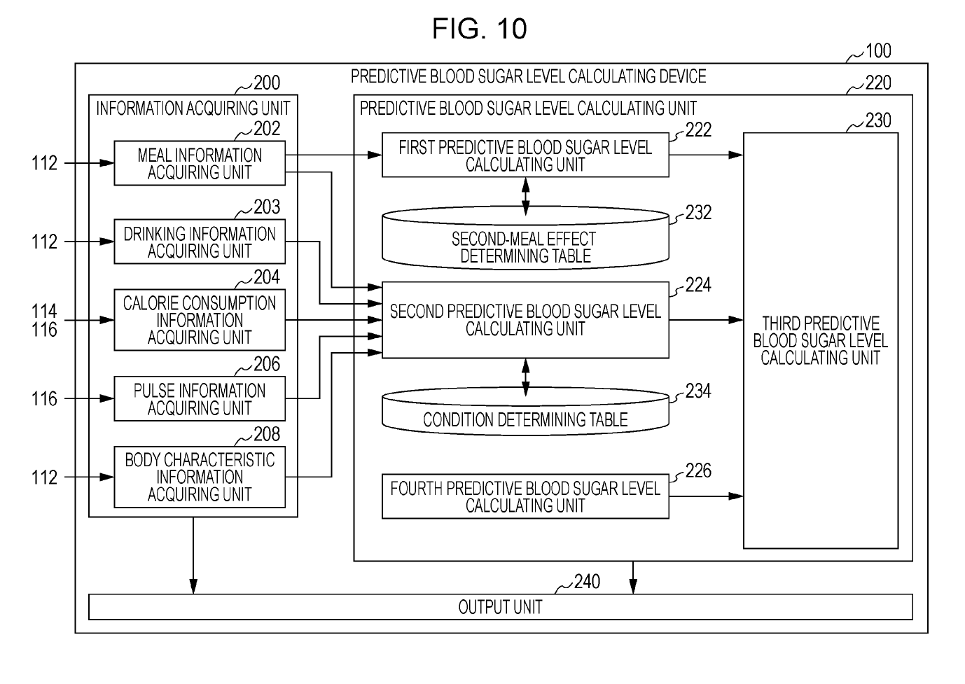

FIG. 10 shows a functional configuration of a predictive blood sugar level calculating device 100 according to a second embodiment. The predictive blood sugar level calculating device 100 according to the second embodiment is different from the predictive blood sugar level calculating device 100 according to the first embodiment, in that the predictive blood sugar level calculating unit 220 further includes a fourth predictive blood sugar level calculating unit 226.

The fourth predictive blood sugar level calculating unit 226 calculates a fourth predictive blood sugar level change curve using basal metabolism information about basal metabolism of the user and a predetermined numerical formula. The fourth predictive blood sugar level change curve indicates a predictive blood sugar level change curve based on the basal metabolism of the user. The third predictive blood sugar level calculating unit 230 can calculate the third predictive blood sugar level change curve also based on the basal metabolism by combining the first predictive blood sugar level change curve calculated by the first predictive blood sugar level calculating unit 222, and the second predictive blood sugar level change curve calculated by the second predictive blood sugar level calculating unit 224, and the fourth predictive blood sugar level change curve calculated by the fourth predictive blood sugar level calculating unit 226. Accordingly, the output unit 240 can output the third predictive blood sugar level change curve also based on the basal metabolism of the user.

For example, with respect to each time during a target period, the third predictive blood sugar level calculating unit 230 calculates a predictive value of a blood sugar level at the corresponding time by further adding an increase or decrease value of the blood sugar level at the corresponding time shown in the fourth predictive blood sugar level change curve. The third predictive blood sugar level calculating unit 230 calculates the third predictive blood sugar level change curve, which is also based on the basal metabolism of the user, indicating change in the predictive value of the blood sugar level in a time series by further adding the increase or decrease in the blood sugar value at the corresponding time shown in the fourth predictive blood sugar level change curve at every time for each unit of time during the target period.

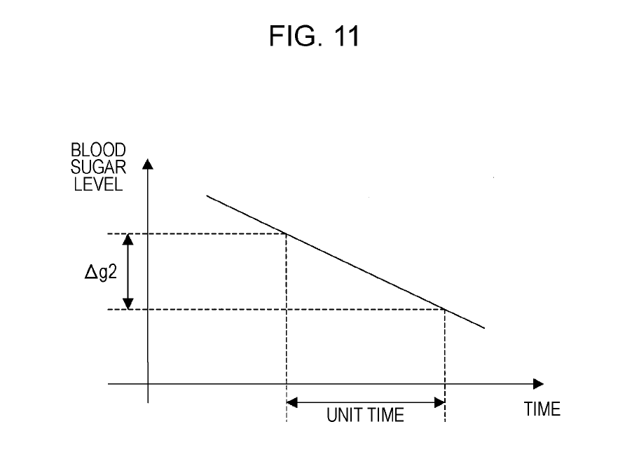

FIG. 11 shows a process of calculating the fourth predictive blood sugar level change curve. The fourth predictive blood sugar level calculating unit 226 calculates the fourth predictive blood sugar level change curve in which the blood sugar level decreases with the elapsing of time. For example, the fourth predictive blood sugar level calculating unit 226 calculates a fourth predictive blood sugar level change curve satisfying a decrease amount Δg2 of the blood sugar level per unit of time. The fourth predictive blood sugar level calculating unit 226 calculates the decrease amount Δg2 of the blood sugar level per unit of time using the following numerical formula (11)

Δg2=KT×s16 (11)

In the numerical formula (11), KT and s16 indicate the basal metabolism information about the basal metabolism of the user. Specifically, KT indicates a basal metabolism rate. A fixed value is used as the basal metabolism rate KT. The basal metabolism rate KT is stored in advance in a recording medium such as the memory of the predictive blood sugar level calculating device 100. The fourth predictive blood sugar level calculating unit 226 acquires the basal metabolism rate KT from the recording medium. A variable value may be used as the basal metabolism rate KT. For example, the basal metabolism rate KT may vary according to each user. The basal metabolism rate KT may vary according to each attribute of users. In such a case, the fourth predictive blood sugar level calculating unit 226 may acquire the basal metabolism rate KT from an external device. For example, the fourth predictive blood sugar level calculating unit 226 may extract the basal metabolism rate KT from the body characteristic information acquired by the body characteristic information acquiring unit 208.

In the numerical formula (11), s16 indicates a coefficient. A fixed value is used as the coefficient s16. The coefficient s16 is stored in advance in a recording medium such as the memory of the predictive blood sugar level calculating device 100. A variable value may be used as the coefficient s16. For example, the coefficient s16 may vary according to each user. The coefficient s16 may vary according to each attribute of users. In such a case, the fourth predictive blood sugar level calculating unit 226 may acquire the coefficient s16 from an external device.

For example, “0.0145 (kcal/sec)” is used as the basal metabolism rate KT. In addition, “−0.95” is used as the coefficient s12. In this case, the fourth predictive blood sugar level calculating unit 226 calculates about “−0.0138 (mg/dL/sec)” as the decrease amount Δg2 of the blood sugar level per unit of time (1 second). As described above, the fourth predictive blood sugar level calculating unit 226 calculates the fourth predictive blood sugar level change curve in which the blood sugar level decreases with the elapsing of time. Particularly, the fourth predictive blood sugar level calculating unit 226 calculates the fourth predictive blood sugar level change curve in which the decrease amount of the blood sugar level per unit of time increases as the basal metabolism rate (calorie consumption at rest) gets higher, using the numerical formula (11).

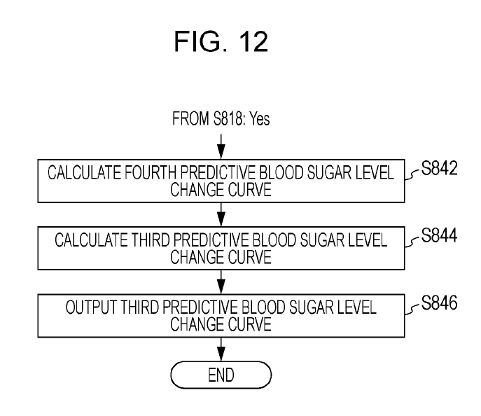

FIG. 12 shows a process sequence of the predictive blood sugar level calculating device 100 according to the second embodiment. In the process flow shown in FIG. 12, Step S802 to Step S824 are the same as the process sequence of the predictive blood sugar level calculating device 100 according to the first embodiment shown in FIG. 8. For this reason, the description of Step S802 to Step S824 is not repeated, and processes of Step S842 onwards, which continue on from S818, will be described hereinafter.

In Step S842, the fourth predictive blood sugar level calculating unit 226 calculates the fourth predictive blood sugar level change curve (Step S842). The third predictive blood sugar level calculating unit 230 calculates the third predictive blood sugar level change curve based on the meal intake of the user, the calorie consumption of the user, and the basal metabolism of the user, by combining the first predictive blood sugar level change curve calculated in Step S810, the second predictive blood sugar level change curve calculated in Step S822, and the fourth predictive blood sugar level change curve calculated in Step S842 (Step S844). The output unit 240 outputs the third predictive blood sugar level change curve calculated in Step S844 (Step S846), and the predictive blood sugar level calculating device 100 ends a series of processes. The predictive blood sugar level calculating device 100 of the embodiment performs the calculation process of the fourth predictive blood sugar level change curve described in Step S842, in units of seconds or minutes, for example, in 4 second units. The calculation process and the output process of the third predictive blood sugar level change curve described in Step S844 to Step S846 are performed in units of seconds or minutes, for example, in 4 second units. As described above, it is possible to provide the latest predictive blood sugar level change curve to the user according to the blood sugar level changing every moment by providing the processing in units of seconds or minutes.

According to the predictive blood sugar level calculating device 100 according to the second embodiment, the fourth predictive blood sugar level change curve is calculated further considering the basal metabolism rate of the user and using the simple calculation formula, and the third predictive blood sugar level change curve is calculated by further combining the fourth predictive blood sugar level change curve. Accordingly, the predictive blood sugar level calculating device 100 can efficiently calculate the third predictive blood sugar level change curve with high precision and with a small error from the actual change in the blood sugar level occurring in the human body.

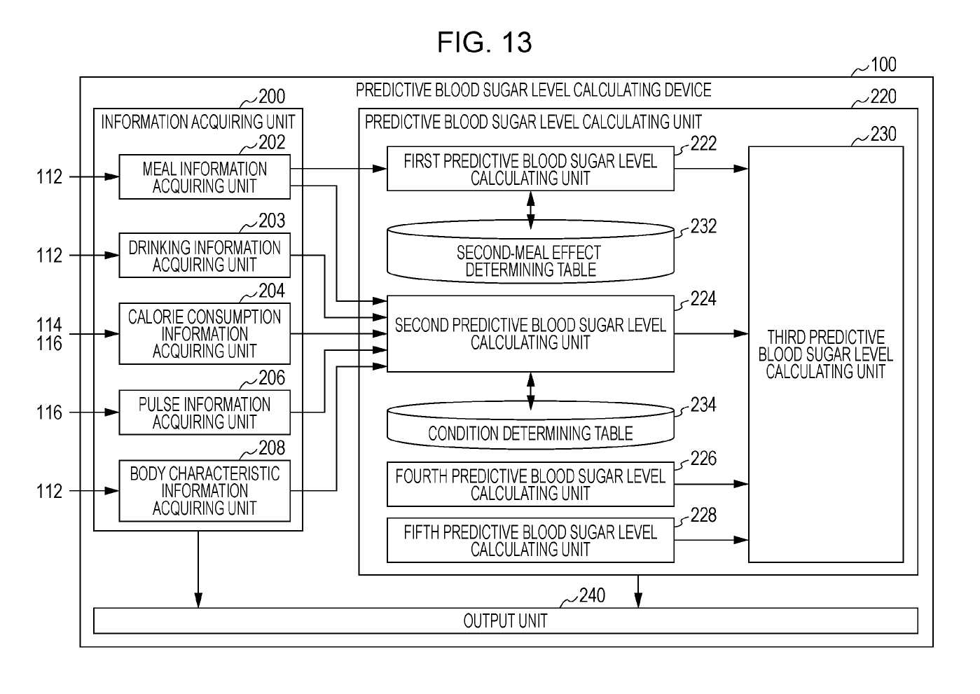

FIG. 13 shows a functional configuration of a predictive blood sugar level calculating device 100 according to a third embodiment. The predictive blood sugar level calculating device 100 according to the third embodiment is different from the predictive blood sugar level calculating device 100 according to the second embodiment, in that the predictive blood sugar level calculating unit 220 further includes a fifth predictive blood sugar level calculating unit 228.

The fifth predictive blood sugar level calculating unit 228 calculates a fifth predictive blood sugar level change curve using liver function information about a liver function of the user and a predetermined numerical formula. The fifth predictive blood sugar level change curve indicates a predictive blood sugar level change curve based on the liver function of the user. The third predictive blood sugar level calculating unit 230 can calculate the third predictive blood sugar level change curve also based on the liver function of the user by combining the first predictive blood sugar level change curve calculated by the first predictive blood sugar level calculating unit 222, and the second predictive blood sugar level change curve calculated by the second predictive blood sugar level calculating unit 224, the fourth predictive blood sugar level change curve calculated by the fourth predictive blood sugar level calculating unit 226, and the fifth predictive blood sugar level change curve calculated by the fifth predictive blood sugar level calculating unit 228. Accordingly, the output unit 240 can output the third predictive blood sugar level change curve also based on the liver function of the user.

For example, with respect to each time during a target period, the third predictive blood sugar level calculating unit 230 calculates a predictive value of a blood sugar level at the corresponding time by further adding an increase or decrease in the blood sugar value at the corresponding time shown in the fifth predictive blood sugar level change curve. The third predictive blood sugar level calculating unit 230 calculates the third predictive blood sugar level change curve, which is also based on the liver function of the user, indicating change in the predictive value of the blood sugar level in a time series by further adding the increase or decrease value of the blood sugar level at the corresponding time shown in the fifth predictive blood sugar level change curve at every time during the target period.

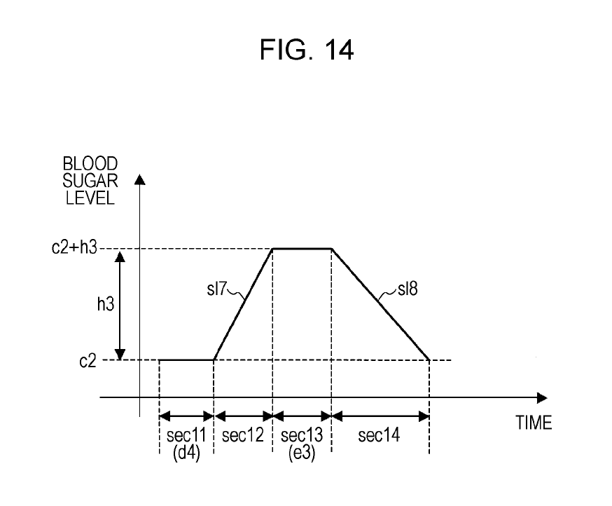

FIG. 14 shows a process of calculating the fifth predictive blood sugar level change curve. The fifth predictive blood sugar level change curve includes a delay period sec11, a rising period sec12, an equilibrium period sec13, and a falling period sec14. The delay period sec11 indicates a period from when the blood sugar level falls below a regulation value to when the blood sugar level starts rising. The rising period sec12 indicates a period from when the blood sugar level starts rising to when the blood sugar level reaches a peak value. The equilibrium period sec13 indicates a period when the blood sugar level is in equilibrium at the peak value. The falling period sec14 indicates a period from when the blood sugar level starts falling from the peak value to when the blood sugar level reaches a regulation value. The fifth predictive blood sugar level calculating unit 228 calculates blood sugar level change curves for each of the plurality of periods. The fifth predictive blood sugar level calculating unit 228 calculates the fifth predictive blood sugar level change curve by combining each of the blood sugar level change curves of the plurality of periods.

First, a method of calculating the blood sugar level change curve for the delay period sec11 will be described. The fifth predictive blood sugar level calculating unit 228 calculates a blood sugar level change curve satisfying the following conditions (l1) to (l3) for the delay period sec11. (l1) The beginning of the delay period sec11 is a point in time when the blood sugar level falls below the regulation value. (l2) The ending of the delay period sec11 is a point in time when a delay time d4 has elapsed since the point in time when the blood sugar level fell below the regulation value. (l3) The delay period sec11 keeps a blood sugar level c2 at the point in time when the blood sugar level falls below the regulation value. A fixed value is used as the delay time d4. The delay time d4 is stored in advance in a recording medium such a memory of the predictive blood sugar level calculating device 100. For example, “15 (minutes)” is used as the delay time d4.

A variable value is used as the regulation value. Specifically, a value varying according to the physical condition of the user. More specifically, a higher value is used as the body of the user is in a worse physical condition. For example, the fifth predictive blood sugar level calculating unit 228 uses “150 (mg/dL)” as the regulation value when the physical condition of the user is The fifth predictive blood sugar level calculating unit 228 uses “130 (mg/dL)” as the regulation value when the physical condition of the user is “2”. The fifth predictive blood sugar level calculating unit 228 uses “110 (mg/dL)” as the regulation value when the physical condition of the user is “3”. The fifth predictive blood sugar level calculating unit 228 uses “100 (mg/dL)” as the regulation value when the physical condition of the user is “4”. The fifth predictive blood sugar level calculating unit 228 uses “90 (mg/dL)” as the regulation value when the physical condition of the user is “5”. The fifth predictive blood sugar level calculating unit 228 determines the physical condition of the user with reference to the physical condition determining table 234 in the same manner as the second predictive blood sugar level calculating unit 224.

Next, a method of calculating the blood sugar level change curve for the rising period sec12 will be described. The fifth predictive blood sugar level calculating unit 228 calculates a blood sugar level change curve satisfying the following conditions (m1) to (m3) for the rising period sec12. (m1) The beginning of the rising period sec12 is the ending of the delay period sec11. (m2) The ending of the rising period sec12 is a point in time when the blood sugar level reaches a sum value of the blood sugar level c2 at the point in time when the blood sugar level falls below the regulation value and a rising value h3 of the blood sugar level. (m3) For the rising period sec12, the blood sugar level rises with a slope s17 when the blood sugar level is rising. For example, the fifth predictive blood sugar level calculating unit 228 calculates the rising value h3 of the blood sugar level using the following numerical formula (12). The fifth predictive blood sugar level calculating unit 228 calculates the slope s17 when the blood sugar level is rising using the following numerical formula (13).

h3=T×GII×sm×ib×l1 (12)

s17=T×GII×m1 (13)

In the numerical formulas (12) and (13), T, GII, sm, ib, l1, and m1 indicate the liver function information about the liver function. T, GII, sm, ib, l1, and m1 are the same as the numerical formulas (1) and (2). However, the numerical formula (12) is different from the numerical formulas (1) and (2) in that fixed values are used as the sugar mass T, the GI value GII, and the second-meal effect value sm. For example, “20.0 (cal)” is used as the sugar mass T. In addition, “3” is used as the GI value GII. In addition, “1.0” is used as the second-meal effect value sm. In the fixed values of the numerical formulas (12) and (13), variable values may be also used in the numerical formulas (12) and (13) in the same manner as the numerical formulas (1) and (2).

Next, a method of calculating the blood sugar level change curve for the equilibrium period sec13 will be described. The fifth predictive blood sugar level calculating unit 228 calculates a blood sugar level change curve satisfying the following conditions (n1) to (n3) for the equilibrium period sec13. (n1) The beginning of the equilibrium period sec13 is the ending of the rising period sec12. (n2) The ending of the equilibrium period sec13 is the point in time when an equilibrium time e3 has elapsed since the beginning of the equilibrium period sec13. (n3) The equilibrium period sec13 keeps a sum value of the blood sugar level c2 at the point in time when the blood sugar level falls below the regulation value and the rising value h3 of the blood sugar level. For example, the fifth predictive blood sugar level calculating unit 228 calculates the equilibrium time e3 using the following numerical formula (14). In the following numerical formula (14), T, GII, n1, and sm are the liver function information, and are the same as the numerical formula (3).

e3=(T×GII×n1)/sm (14)

Next, a method of calculating the blood sugar level change curve for the falling period sec14 will be described. The fifth predictive blood sugar level calculating unit 228 calculates a blood sugar level change curve satisfying the following conditions (o1) to (o3) for the falling period sec14. (o1) The beginning of the falling period sec14 is the ending of the equilibrium period sec13. (o2) The ending of the falling period sec14 is a point in time when the blood sugar level reaches the blood sugar level c2 at the point in time when the blood sugar level falls below the regulation value. (o3) For the falling period sec14, the blood sugar level falls with a slope s18 when the blood sugar level is falling. For example, the fifth predictive blood sugar level calculating unit 228 calculates the slope s18 when the blood sugar level is falling using the following numerical formula (15). In the following numerical formula (15), T, GII, and p1 are the liver function information, and are the same as the numerical formula (4).

s18=T×GII×p1 (15)

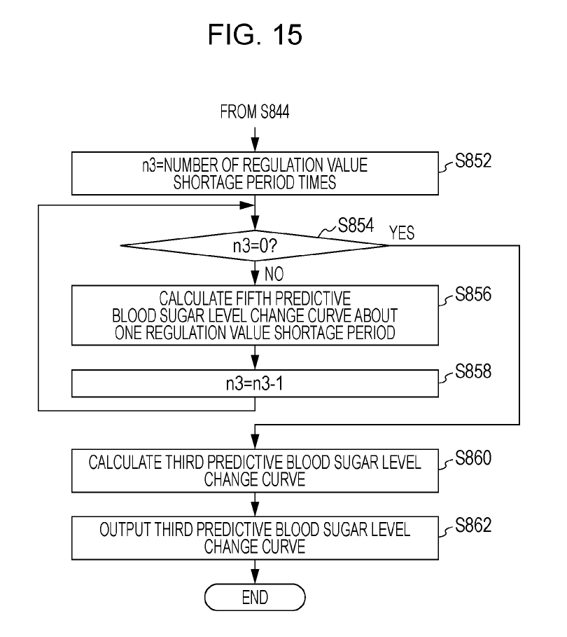

FIG. 15 shows a process sequence of the predictive blood sugar level calculating device 100 according to the third embodiment. In the process flow shown in FIG. 15, Step S802 to Step S844 are the same as the process sequence of the predictive blood sugar level calculating device 100 according to the second embodiment shown in FIG. 12. For this reason, the description of Step S802 to Step S844 is not repeated, and processes of Step S852 onwards, which continue on from S844, will be described hereinafter.

In Step S852, the fifth predictive blood sugar level calculating unit 228 stores the number of blood sugar level shortage periods shown in the third predictive blood sugar level change curve calculated in Step S844, in the variable n3 (Step S852).

Then, the fifth predictive blood sugar level calculating unit 228 determines whether or not the value of the variable n3 is 0 (Step S854). In Step S854, when it is determined that the value of the variable n3 is 0 (Step S854: Yes), the predictive blood sugar level calculating device 100 proceeds the process to Step S860. In Step S854, when it is determined that the value of the variable n3 is not 0 (Step S854: No), the fifth predictive blood sugar level calculating unit 228 calculates the fifth predictive blood sugar level change curve about one blood sugar level shortage period among the blood sugar level shortage periods shown in the third predictive blood sugar level change curve calculated in Step S844 (Step S856). The fifth predictive blood sugar level calculating unit 228 stores a value, which is obtained by subtracting 1 from the value stored in the variable n3, in the variable n3 (Step S858), and returns the process to Step S854. The fifth predictive blood sugar level calculating unit 228 repeatedly performs Step S854 to Step 858 until the fifth predictive blood sugar level change curve is calculated for every blood sugar level shortage period.

In Step S860, the third predictive blood sugar level calculating unit 230 calculates the third predictive blood sugar level change curve based on the meal intake of the user, the calorie consumption of the user, the basal metabolism of the user, and the liver function of the user, by combining the first predictive blood sugar level change curve calculated in Step S810, the second predictive blood sugar level change curve calculated in Step S822, the fourth predictive blood sugar level change curve calculated in Step S826, and the fifth predictive blood sugar level change curve calculated in Step S856 (Step S860). The output unit 240 outputs the third predictive blood sugar level change curve calculated in Step S860 (Step S862), and the predictive blood sugar level calculating device 100 ends a series of processes. The predictive blood sugar level calculating device 100 of the embodiment performs the calculation process of the fifth predictive blood sugar level change curve described in Step S852 to Step S858, in units of seconds or minutes, for example, in 4 second units. The calculation process and the output process of the third predictive blood sugar level change curve described in Step S860 to Step S862 are performed in units of seconds or minutes, for example, in 4 second units. As described above, it is possible to provide the latest predictive blood sugar level change curve to the user according to the blood sugar level changing every moment by providing the processing in units of seconds or minutes.

According to the predictive blood sugar level calculating device 100 according to the third embodiment, the fifth predictive blood sugar level change curve is calculated further considering the liver function of the user and using the simple calculation formula, and the third predictive blood sugar level change curve is calculated by further combining the fifth predictive blood sugar level change curve. Accordingly, the predictive blood sugar level calculating device 100 can efficiently calculate the third predictive blood sugar level change curve with high precision and with a small error from the actual change in the blood sugar level occurring in the human body.

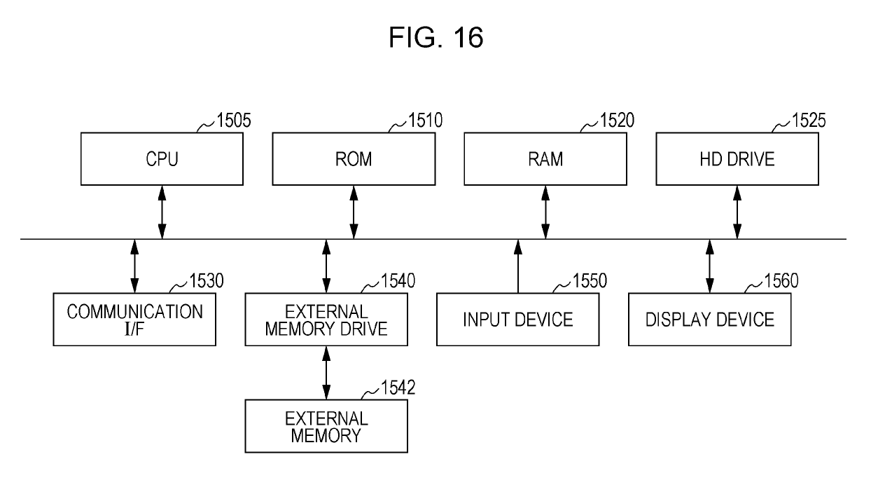

FIG. 16 shows a hardware configuration of the predictive blood sugar level calculating device 100. The predictive blood sugar level calculating device 100 is provided with a CPU 1505, a ROM 1510, a RAM 1520, a HD (hard disk) drive 1525, a communication interface 1530, an external memory drive 1540, an external memory 1542, an input device 1550, and a display device 1560.

The ROM 1510, the RAM 1520, and the HD drive 1525 store various kinds of data and various kinds of programs. The CPU 1505 executes the program stored in the ROM 1510, the RAM 1520, or the HD drive 1525 to process various kinds of data and to control various kinds of hardware. The predictive blood sugar level calculating device 100 may be provided with another recording medium such as a flash memory, instead of the HD drive 1525. The predictive blood sugar level calculating device 100 may not be provided with the HD drive 1525. In this case, in the predictive blood sugar level calculating device 100, the other recording medium such as the ROM 1510 may have the function of the HD drive 1525. The program executed by the CPU 1505 causes the predictive blood sugar level calculating device 100 (i.e., computer) to function as the information acquiring unit 200, the predictive blood sugar level calculating unit 220, and the output unit 240 described with reference to FIG. 1 to FIG. 15.

The communication interface 1530 is connected to a communication network to transmit and receive data to and from an external device through the communication network. The external memory drive 1540 is connected to the external memory 1542 to transmit and receive the data to and from the external memory 1542. Examples of the external memory 1542 include a memory card. The external memory 1542 may be a recording medium such as a flexible disk, a CD, and a DVD.

The display device 1560 displays various kinds of data. Examples of the display device 1560 may include a CRT display, a liquid crystal display, a plasma display, an organic EL display, and an electronic paper. The input device 1550 inputs operations to the predictive blood sugar level calculating device 100. An example of the input device 1550 may include a mouse, a keyboard, an input button, and a touch panel.

The program executed by the CPU 1505 may be stored in, for example, the external memory 1542, and may be provided to the predictive blood sugar level calculating device 100, to be installed in the predictive blood sugar level calculating device 100. The program executed by the CPU 1505 may be provided from the external device to the predictive blood sugar level calculating device 100 through the communication network, to be installed in the predictive blood sugar level calculating device 100.

The first embodiment to the third embodiment of the invention have been described above, but the invention is not limited to the first embodiment to the third embodiment, and may be variously embodied. For example, the first embodiment to the third embodiment may be modified as follows to embody the invention.

The device configuration of the predictive blood sugar level calculating system 10 is not limited to the configuration shown in FIG. 1. For example, the predictive blood sugar level calculating system 10 may not be provided with the predictive blood sugar level calculating device 100, and one of the terminal device 112, the activity meter 114, or the pulsimeter 116 may have the function of the predictive blood sugar level calculating device 100. The predictive blood sugar level calculating system 10 may not be provided with the activity meter 114, and the terminal device 112 or the pulsimeter 116 may have the function of the activity meter 114. The predictive blood sugar level calculating system 10 may not be provided with the pulsimeter 116, and the terminal device 112 or the activity meter 114 may have the function of the pulsimeter 116. The predictive blood sugar level calculating system 10 may be provided with an information processing device having all the functions of the terminal device 112, the activity meter 114, the pulsimeter 116, and the predictive blood sugar level calculating device 100.

The predictive blood sugar level calculating system 10 may be further provided with a relay device such as a personal computer and a mobile information terminal which relays data between the input device group 110 and the predictive blood sugar level calculating device 100. In this case, the relay device may accumulate the various kinds of data transmitted from the input device group 110, and may transmit the various kinds of accumulated data to the predictive blood sugar level calculating device 100 at a predetermined time or a time designated by the user. The relay device may be provided in any one of the terminal device 112, the activity meter 114, or the pulsimeter 116.

The predictive blood sugar level calculating unit 220 may selectively calculate one or more different kinds of a plurality of predictive blood sugar level change curves (the first predictive blood sugar level change curve, the second predictive blood sugar level change curve, the fourth predictive blood sugar level change curve, and the fifth predictive blood sugar level change curve). The predictive blood sugar level calculating unit 220 may calculate the third predictive blood sugar level change curve by combining the plurality of selectively calculated predictive blood sugar level change curves. For example, the predictive blood sugar level calculating unit 220 may selectively calculate one or more predictive blood sugar level change curves according to a selection instruction of the user. The predictive blood sugar level calculating unit 220 may selectively calculate one or more predictive blood sugar level change curves according to process capability of the predictive blood sugar level calculating device 100. The predictive blood sugar level calculating unit 220 may selectively calculate one or more predictive blood sugar level change curves according to service contents using the predictive blood sugar level calculating system 10.

The predictive blood sugar level calculating unit 220 may selectively determine a process of actually performing the process among a plurality of processing processes included in the process when the process of calculating the predictive blood sugar level change curves is performed. For example, the predictive blood sugar level calculating unit 220 may selectively determine the processing process of actually performing the treatment according to a selection instruction of the user. The predictive blood sugar level calculating unit 220 may selectively determine the processing process of actually performing the treatment according to process capability of the predictive blood sugar level calculating device 100. The predictive blood sugar level calculating unit 220 may selectively determine the processing process of actually performing the treatment according to service contents using the predictive blood sugar level calculating system 10.

The predictive blood sugar level calculating unit 220 may calculate various kinds of predictive blood sugar level change curves selectively using one or more parameters, which are not essential, among a plurality of input parameters. For example, the predictive blood sugar level calculating unit 220 may calculate the various kinds of predictive blood sugar level change curves selectively using one or more parameters, which are not essential, according to a selection instruction of the user. The predictive blood sugar level calculating unit 220 may calculate the various kinds of predictive blood sugar level change curves selectively using one or more parameters, which are not essential, according to process capability of the predictive blood sugar level calculating device 100. The predictive blood sugar level calculating unit 220 may calculate the various kinds of predictive blood sugar level change curves selectively using one or more parameters, which are not essential, according to service contents using the predictive blood sugar level calculating system 10.

The output unit 240 may output one or more of different kinds of a plurality of predictive blood sugar level change curves (the first predictive blood sugar level change curve, the second predictive blood sugar level change curve, the fourth predictive blood sugar level change curve, the fifth predictive blood sugar level change curve, and the third predictive blood sugar level change curve). For example, the output unit 240 may selectively output one or more predictive blood sugar level change curves according to a selection instruction of the user. The output unit 240 may selectively output one or more predictive blood sugar level change curves according to process capability of the predictive blood sugar level calculating device 100. The output unit 240 may selectively output one or more predictive blood sugar level change curves according to service contents using the predictive blood sugar level calculating system 10.

A method of obtaining the meal information by the terminal device 112 may be any method. For example, the terminal device 112 may make the user input the meal information. The terminal device 112 may make the user input the meal contents, and may calculate the meal information on the basis of the meal contents with reference to a meal database in which the meal contents and the meal information are associated and stored. In this case, the meal database may be provided in the terminal device 112 or may be provided in an external device. The terminal device 112 may transmit the meal contents to the predictive blood sugar level calculating device 100. In this case, the predictive blood sugar level calculating device 100 may calculate the meal information on the basis of the meal contents transmitted from the terminal device 112 with reference to a meal database in which the meal contents and the meal information are associated and stored. In this case, the meal database may be provided in the predictive blood sugar level calculating device 100 or may be provided in an external device.

The terminal device 112 may have a function of automatically recognizing the meal contents. For example, the terminal device 112 may automatically recognize the meal contents by reading barcodes attached to tableware, receipts, and the like. The terminal device 112 may automatically recognize the meal contents by reading information indicating the meal contents from IC tags attached to tableware, receipts, and the like. The terminal device 112 may automatically recognize the meal contents by taking an image of the meal and performing an image recognizing process for the meal image.

What is claimed is:

1. A predictive blood sugar level calculating device, which calculates a predictive blood sugar level change curve indicating change in a predictive value of a blood sugar level of a user in a time series, the device comprising:
a meal information acquiring unit that acquires meal information about meal intake of the user;
a calorie consumption information acquiring unit that acquires calorie consumption information about calorie consumption of the user;
a first predictive blood sugar level calculating unit that calculates a first predictive blood sugar level change curve based on the meals using the meal information and a predetermined numerical formula;
a second predictive blood sugar level calculating unit that calculates a second predictive blood sugar level change curve based on the calorie consumption using the calorie consumption information and a predetermined numerical formula; and
a third predictive blood sugar level calculating unit that calculates a third predictive blood sugar level change curve based on the meals and the calorie consumption by combining the first predictive blood sugar level change curve and the second predictive blood sugar level change curve.

2. The predictive blood sugar level calculating device according to claim 1, further comprising a drinking information acquiring unit that acquires drinking information about drinking of the user, wherein the second predictive blood sugar level calculating unit calculates a predictive calorie consumption change curve indicating change in a predictive value of calorie consumption in a time series when the user drinks using the drinking information and a predetermined numerical formula, and calculates the second predictive blood sugar level change curve when the user drinks using the predictive calorie consumption change curve and a predetermined numerical formula.

3. The predictive blood sugar level calculating device according to claim 1, wherein the second predictive blood sugar level calculating unit calculates the second predictive blood sugar level change curve with respect to a period when the calorie consumption information cannot be acquired using calorie consumption information of a different period when the calorie consumption information can be acquired and a predetermined numerical formula.

4. The predictive blood sugar level calculating device according to claim 1, further comprising a fourth predictive blood sugar level calculating unit that calculates a fourth predictive blood sugar level change curve based on basal metabolism using basal metabolism information about the basal metabolism of the user and a predetermined numerical formula, wherein the third predictive blood sugar level calculating unit calculates the third predictive blood sugar level change curve based on the meals, the calorie consumption, and the basal metabolism by combining the first predictive blood sugar level change curve, the second predictive blood sugar level change curve, and the fourth predictive blood sugar level change curve.

5. The predictive blood sugar level calculating device according to claim 4, further comprising a fifth predictive blood sugar level calculating unit that calculates a fifth predictive blood sugar level change curve based on a liver function using liver function information about the liver function of the user and a predetermined numerical formula, wherein the third predictive blood sugar level calculating unit calculates the third predictive blood sugar level change curve based on the meals, the calorie consumption, the basal metabolism, and the liver function by combining the first predictive blood sugar level change curve, the second predictive blood sugar level change curve, the fourth predictive blood sugar level change curve, and the fifth predictive blood sugar level change curve.

6. The predictive blood sugar level calculating device according to claim 4, wherein the predictive blood sugar level calculating device selectively calculates different kinds of a plurality of predictive blood sugar level change curves, and the third predictive blood sugar level calculating unit calculates the third predictive blood sugar level change curve by combining the plurality of selectively calculated predictive blood sugar level change curves.

7. The predictive blood sugar level calculating device according to claim 1, wherein the third predictive blood sugar level calculating unit calculates the third predictive blood sugar level change curve at every predetermined unit of time.

8. A predictive blood sugar level calculating method by a predictive blood sugar level calculating device, which calculates a predictive blood sugar level change curve indicating change in a predictive value of a blood sugar level of a user in a time series, the method comprising:
acquiring meal information about meal intake of the user, by a meal information acquiring unit of the predictive blood sugar level calculating device;
acquiring process of acquiring calorie consumption information about calorie consumption of the user, by a calorie consumption information acquiring unit of the predictive blood sugar level calculating device;
calculating a first predictive blood sugar level change curve based on the meals using the meal information and a predetermined numerical formula, by a first predictive blood sugar level calculating unit of the predictive blood sugar level calculating device;
calculating a second predictive blood sugar level change curve based on the calorie consumption using the calorie consumption information and a predetermined numerical formula, by a second predictive blood sugar level calculating unit of the predictive blood sugar level calculating device; and
calculating a third predictive blood sugar level change curve based on the meals and the calorie consumption by combining the first predictive blood sugar level change curve and the second predictive blood sugar level change curve, by a third predictive blood sugar level calculating unit of the predictive blood sugar level calculating device.

9. A program for a predictive blood sugar level calculating device, which calculates a predictive blood sugar level change curve indicating change in a predictive value of a blood sugar level of a user in a time series, the program causing a computer to function as:
a meal information acquiring unit that acquires meal information about meal intake of the user;
a calorie consumption information acquiring unit that acquires calorie consumption information about calorie consumption of the user;
a first predictive blood sugar level calculating unit that calculates a first predictive blood sugar level change curve based on the meals using the meal information and a predetermined numerical formula;
a second predictive blood sugar level calculating unit that calculates a second predictive blood sugar level change curve based on the calorie consumption using the calorie consumption information and a predetermined numerical formula; and
a third predictive blood sugar level calculating unit that calculates a third predictive blood sugar level change curve based on the meals and the calorie consumption by combining the first predictive blood sugar level change curve and the second predictive blood sugar level change curve.
